(19) United States
(12) Patent Application Publication
(10) Pub. No.: US 2008/0020947 A1
(43) Pub. Date: Jan. 24, 2008

(54) Novel microorganisms having oil biodegradability and method for bioremediation of oil-contaminated soil

(76) Inventors: Byeong-Deog Park, Dajeon (KR); Myung-Jin Lee, Dajeon (KR); Mi-Jong Kwon, Dajeon (KR); Hyung-Sub Gwak, Dajeon (KR); Myung-Kyum Kim, Dajeon (KR); Yoon Kim, Dajeon (KR)

Correspondence Address: Thomas M. Galgano, Esq.;GALGANO & ASSOCIATES, PLLC, 20 West Park Avenue, Suite 204, Long Beach, NY, 11561, US

(21) Appl. No.: 11/544,900

(22) Filed: Oct. 6, 2006

(30) Foreign Application Priority Data
Jul. 18, 2006 (KR) 10-2006-0067042

(51) Int. Cl. G06K 9/00; C09K 8/14; C09K 8/05; C04B 33/04

(52) U.S. Cl. 507/101; 507/100

(57) ABSTRACT

Disclosed herein are novel microorganisms having excellent biodegradability and a method for the bioremediation of oil-contaminated soil. The novel microorganisms are specified as Rhodococcus baikoneurensis EN3 KCTC19082, Acinetobacter johnsonii EN67 KCTC12360 and Acinetobacter haemolyticus EN96 KCTC12361. In the bioremediation method, in addition to said novel microorganisms, various microorganisms of Nocardia sp., Gordonia sp., Rhodococcus sp. and Acinetobactor sp. can be used, and the oil biodegradation activities of these microbial strains can be increased by adding biosurfactant 2-alkyl-3-hydroxylic acid or its derivative. According to the disclosed invention, oil-contaminated soils can be purified in an effective, economical and eco-friendly manner compared to prior bioremediation methods.

### BACKGROUND OF THE INVENTION

1. Field of the Invention

The present invention relates to novel microorganisms having excellent oil biodegradability and a method for the bioremediation of oil-contaminated soil, and more particularly to novel microorganisms having excellent oil biodegradability and an economical, effective and eco-friendly method for the bioremediation of oil-contaminated soil, which uses various microorganisms, including said novel microorganisms, and a specific biosurfactant.

2. Description of the Prior Art

Generally, subjects, to which technology for the bioremediation of contaminated soil is applied, include soils contaminated with oil or chemicals used in factories and the like, beaches contaminated by oil spills and the like, sludge containing hydrophobic contaminants, and soils neighboring oil stations or oil reservoirs.

Methods for removing hydrophobic contaminants from contaminated soils may include techniques such as soil vapor extraction (SVE), soil flushing, soil washing, incineration, low-temperature thermal desorption (LTTD), bioventing, bioaugmentation, land farming, biopile and bioreactor methods. Such methods will now be briefly described.

The soil vapor extraction (SVE) method is a technique of removing volatile and semi-volatile contaminants from soils by making the soils vacuous. In this case, the collection and treatment of volatile organic compounds (VOC) extracted from the soils become secondary problems.

The soil flushing method is a technique comprising injecting water containing additives such as surfactants, or pure water, into contaminated soils or underground water, extracting the contaminants from the oil-contaminated sites and then returning the treated water, from which the contaminants have been treated and purified, to the contaminated areas.

The soil washing method is a technique of separating the organic contaminants and heavy metals bound to soil particles, using suitable washing agents, and can be broadly divided, according to an application method, into in-situ soil flushing and ex-situ soil washing.

In the soil flushing and soil washing methods, synthetic surfactants such as nonionic surfactants have been used, but there has been a concern about secondary soil contamination caused by the synthetic surfactants adsorbed and remaining on the soil. Particularly, synthetic surfactants having low biodegradability are difficult to apply to the soil flushing method, because the surfactants themselves are contamination sources. For this reason, the use of biosurfactants such as rhamnolipid and emulsian has recently been reported. However, in cases such as the soil flushing method in which the use of large amounts of surfactants, the biosurfactants are greatly disadvantageous compared to the synthetic surfactants, because these are not economical in terms of costs.

The incineration method is a thermal breakdown process in which organic substances are burned and degraded by supplying oxygen.

The low-temperature thermal desorption method, also called “low-temperature thermal volatilzation method”, is an ex-situ treatment technique in which heat (90-320° C.) is used to physically degrade petroleum hydrocarbons from excavated soil.

The bioventing method is also called “biostimulation method”, in which air, moisture, nutrient material and the like are injected into contaminated soils in order to stimulate the activation of degradation microorganisms in the soils. In this case, it is important to how the activity of degradation microorganisms in contaminated soils is enhanced. According to recent reports, if microorganisms degrade microbiological nutrient sources such as diesel oil, the surface contact between oil contaminants and the microorganisms must be accompanied, in which case biosurfactants reduce the interfacial tension between the oil contaminants and the microorganisms to increase the bioavailability of the microorganisms for oil contaminants. Thus, the biosurfactants can serve as an important factor in the biostimulation method. However, highly toxic synthetic surfactants have limited use, because these do not activate microorganisms, but rather suppress the growth of the microorganisms.

The bioaugmentation method is a method in which, if the proliferation of microorganisms degrading target contaminants on contaminated soils is not smooth, microorganisms separately cultured in the external environment are introduced so as to induce microbiological purification.

The land farming method is a method in which contaminated soil is excavated, laid on the ground surface and periodically turned over, so that the contact area between the soil and air is increased to stimulate the activation of oil-degrading microorganisms living in the soil.

The biopile method is a method in which, if the area of a site used as a contaminant treatment plant is small, contaminated soil is excavated, piled and treated on the ground. In this method, contaminated soil is purified by injecting nutrients and microorganisms using a soil purification system, which can inject air and the like.

The bioreactor method is a method of stimulating the biodegradation of oil by adding water together with suitable additives to excavated contaminated soil, and introducing and stirring the soil in a bioreactor so as to activate soil microorganisms.

However, although the above methods have respective advantages, these are not suitable for almost completely purifying various soil layers, which are contaminated with various types of oil or which contain various soil types, shapes and water contents.

Meanwhile, in the prior methods that use microorganisms, microorganisms having the ability to selectively degrade each type of oil with high efficiency should preferably be used in combination with each other so as to be able to effectively purify contaminated soils, because the contaminated soils are mostly contaminated with various types of oil, rather than a single kind of oil. However, among microorganisms identified to date, many kinds of microorganisms have oil biodegradation ability, but have low biodegradation ability depending on the property of each microorganism or show selective biodegradation ability according to the kind of oil. Furthermore, these microorganisms are inhibited with respect to the proliferation thereof in sites contaminated with high concentrations of oil. Due to such problems, these microorganisms are not sufficiently satisfied for the bioremediation of soil contaminated with oil.

Meanwhile, synthetic surfactants, which have been industrialized starting from the early 20^{th} century, have been continuously developed and are currently used in a wide range of industrial applications, including medical drugs, cosmetics, agricultural chemicals and detergents. However, because these synthetic surfactants cause environmental contamination problems, substitution with eco-friendly surfactants derived from natural sources has been attempted. Particularly in cosmetics, beverages and medical drugs, affinity for biosystems, mild properties and the like have become very important factors, and thus biosurfactants receive great attention.

In a wide sense, the biosurfactants are defined as surfactant substances produced inside and outside the cells of organisms, and are characterized in that these have unique chemical structures and various functional groups and show excellent biodegradability and stability. The biosurfactants are amphiphilic substances having hydrophilic and hydrophobic groups and are defined as surfactant substances, which are present in microbial, animal or plant cells or secreted by microorganisms. Microorganisms secreting the biosurfactants are frequently found in nature, particularly in areas including oil-contaminated soil, in which ultrahydrophobic substances are present. Regarding the production of such biosurfactants, in order to use hydrophobic substances as carbon sources/energy sources, the surface or interfacial tension between the hydrophobic substances and microbial surfaces is reduced to facilitate a process in which the microorganisms absorb the hydrophobic substances, thus facilitating the growth of the microorganisms. Also, it is known that non-mobile microorganisms produce and secrete biosurfactants in order to ensure their territories or slide during movement.

Starting from the mid-1970's, many surfactant substances in the form of mixtures produced by microorganisms have been discovered as a result of studies on hydrocarbon fermentation processes. These surfactant substances are divided, according to the kind of hydrophilic groups therein, into glycolipids, lipoproteins or lipopeptides, phospholipids, fatty acids, and polymeric biosurfactants.

The biosurfactants generally reduce surface (interfacial) tension and have excellent emulsifying and dispersing abilities and low critical micelle concentration. However, despite such advantages, very few surfactants have been commercialized to date.

The reason for this is due to low production yield and high cost, which result from production process optimization and technical problems such as the purification and separation of produced byproducts.

Thus, it is almost impossible to use large amounts of the biosurfactants either for the purification of sea or soil contaminants over wide areas, in which these are not effective in small amounts, or for industrial purposes.

For this reason, the structures of the biosurfactants were already found through the semi-synthesis or total synthesis thereof, and attempts to obtain biosurfactants or their derivatives or analogues, which are relatively easily purified and have high yields and thus are cost-effective, have been conducted.

2-alkyl-3-hydroxy fatty acid, a fatty acid-based biosurfactant, is produced by various microorganisms in nature and called “corynomycolic acid”, “nocardomycolic acid”, mycolic acid” and the like, according to the names of microbial strains producing them. These generally have 22-90 total carbon atoms, and 6-24 carbon atoms in the alkyl group.

The alkyl group in 2-alkyl-3-hydroxy fatty acid is present in the form of various lengths of a straight chain group including hydroxy, methoxy, keto, carbonyl, carboxyl, epoxy ester or a cyclopropane ring, and contains a cis or trans double bond therein or other branched-chain fatty acids therein.

Among these, there are many studies and reports on corynomycolic acid, according to which corynomycolic acid has 22-39 total carbon atoms, and 6-14 carbon atoms in the branched alkyl group, and shows a very low interfacial tension compared to those of simple fatty acids or higher alcohols, and the effect thereof is maintained over a wide range of pH 2-10. Also, it shows high ability to penetrate into fibers and also has an excellent ability for dispersing poorly soluble solid fine particles. It is known that these properties are connected with that corynomycolic acid has two alkyl groups in the structure, and the 3-hydroxyl group forms a six-membered ring hydrogen bond with the carbonyl group of the carboxyl group.

Corynomycolic acid is produced in the form of trehalose diester by Mycobacterium sp. bacteria in a biosynthesis process [D. Cooper, et al., Appl. Environ. Microbiol., 37, 4 (1979)], and is also produced in the form of free acid by Arthrobacter, Norcardia, Corynebacterium, Rhodococcus, Gordonia, Bacterionema, Micropolyspora or Brevibacterium bacteria in a fermentation process [D. Cooper, et al., J. Amer. Oil. Chem. Soc., 58, 77 (1981)]. However, a separate complicated purification process was necessarily conducted in order to obtain only desired components, because the yield thereof was as low as less than 1 g per liter of a culture solution, and various analogue mixtures were also obtained.

Naturally, 2-alkyl-3-hydroxy fatty acid is present in a state bound to an arabinogalactan-peptidoglycan matrix as an important component of the microbial cell wall. In some cases, it is also secreted in the form of a glycolipid biosurfactant ester-linked to the hydroxyl group of trehalose secreted by microorganisms.

M. Utaka et al. reported a four-step method in which 2-tetradecyl-3-hydroxy octadecanoic acid having 32 total carbon atoms and showing optical activity is produced with a total yield of about 15% from methyl 3-oxoester by selective reduction using Baker's yeast [J. Chem. Soc. Chem. Commun., 1368 (1987)]. Although the production yield using this method was greater than that using the biosynthesis method, it is still not sufficiently satisfactory, and reagents used for the synthesis are relatively expensive. Thus, this method still has room for improvement in industrial terms.

Meanwhile, Y. Ishigami et al. reported a method of synthesizing 2-alkyl-3-hydroxy fatty acids having 16 and 24 total carbon atoms with a total yield of about 40% by subjecting fatty acid ester to Claisen condensation to obtain 2-alkyl-3-oxoester, substituting the 3-oxo group of the 2-alkyl-3-oxoester with a 3-hydroxyl group using a reducing agent, hydrolyzing the substituted product in the presence of a base and then treating the hydrolyzed product with acid [J. Jpn. Oil Chem. Soc., 38, 1001 (1989)].

T. Fujii et al. synthesized 2-alkyl-3-hydroxy fatty acids having 12, 16, 20, 24 and 28 total carbon atoms, and salts thereof, using some modifications of said method. Although this method was an improvement with respect to yield or the production process compared to the previously known methods, an increase in total carbon atoms led to a great decrease in yield. Specifically, when the total carbon atoms were 24 and 28 in number, the yields were 10-16% [J. Jpn. Oil Chem. Soc., 44, 3 (1995)].

Said method consists of a multistep reaction comprising a first step of obtaining oxoester starting from fatty acid ester, a second step of reducing the produced oxoester, and then a third step of hydrolyzing the reduced product. As the base used in Claisen condensation, the first-step reaction, sodium hydride is generally used in the form of an oil dispersion, because it reacts intensively with water and has the risk of causing fire. This method has problems in that it is difficult to perform separation and purification from the oil phase after the condensation reaction, because the starting material and product of the condensation reaction are all esters, and in that an increase in the number of alkyl groups leads to a decrease in yield. Other problems pointed out include a decrease in yield during both the reduction reaction and the hydrolysis reaction, and a decrease in economy due to the use of various utilities required for separation and purification.

In a prior attempt to improve the above-described problems, a method of obtaining 2-alkyl-3-hydroxy fatty acid using an easily commercially available alkyl ketene dimmer as a starting material was suggested. This prior method comprises a first step of subjecting the alkyl ketene dimer to ring-opening reaction in the presence of a base to prepare a 2-alkyl-3-oxo fatty acid salt, and a second step of reducing the 2-alkyl-3-oxo fatty acid salt obtained in the first step into a 2-alkyl-3-hydroxy fatty acid salt, using a reducing agent. This prior method has advantages in that, because it is conducted in the presence of a base, the activity of the reducing agent added subsequently is maintained so that the reaction can be performed without using an excess of the reducing agent, and in that only two reaction steps are relatively simple. Also, because the reaction can be carried out by sequentially adding reaction reagents into the same reactor, a separation process for each of the steps is not required, and thus the hydroxy fatty acid can be very economically synthesized. However, the prior method has problems in that, when reaction conditions are severe, the 2-alkyl-3-oxo fatty acid produced by the ring-opening reaction is left in the form of carbon dioxide by dicarboxylation to form ketone, resulting in a reduction in reaction yield, and in that the carboxyl group of the produced 2-alkyl-3-oxo fatty acid should be activated in order to convert the fatty acid into sugars or new biosurfactant derivatives.

In a method for the bioremediation of oil-contaminated soils according to the present invention, various kinds of microorganisms having excellent oil biodegradability, including novel microorganisms, are effectively used, and the biosurfactant 2-alkyl-3-hydroxylic acid or its derivative, which are produced in an effective and economical manner, is used as an activating agent which can increase the oil biodegradation activity of the microorganisms.

Specifically, the biosurfactant 2-alkyl-3-hydroxylic acid or its derivative can be effectively used as an activating agent capable of increasing the biodegradation activity of microorganisms that can effectively degrade and remove contaminants of oil-contaminated soils in bioremediation technologies of soil contamination, including bioventing, bioaugmentation, land farming), biopile and bioreactor methods. In addition, the biosurfactant hydroxylic acid or its derivative can also be effectively used as a soil washing agent in bioremediation technologies of soil contamination, such as soil flushing and soil washing methods, for soils contaminated with types of oil such as diesel oil, bunker C oil and jet oil.

### SUMMARY OF THE INVENTION

Accordingly, the present invention has been made keeping in mind the above problems occurring in the prior art, and a first object of the present invention is to provide novel microorganisms, which can be applied to a wide spectrum of oil contaminants and, at the same time, have excellent oil biodegradability.

A second object of the present invention is to provide a method for the bioremediation of oil-contaminated soils, which uses microorganisms having excellent oil biodegradability, including the novel microorganisms according to the first object.

A third object of the present invention is to provide a method for the bioremediation of oil-contaminated soils, which uses an activating agent as a biosurfactant, which is eco-friendly and does not have the risk of causing secondary environmental contamination, such that the ability of said microorganisms to biodegrade contaminants can be increased while the proliferation of the microorganisms is not inhibited by contaminants even in a contamination state with a relatively high concentration of oil.

A fourth object of the present invention is to provide an effective and economical method for producing the activating agent according to the third object.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows a phylogenetic tree of Rhodococcus baikoneurensis EN3, a novel microbial strain according to the present invention;

FIG. 2 shows a phylogenetic tree of Acinetobacter johnsonii EN67 and Acinetobacter haemolyticus EN96, which are novel microbial strains according to the present invention;

FIG. 3 is a scanning electron microscope photograph of the novel microbial strain EN3;

FIG. 4 is a scanning electron microscope photograph of the novel microbial strain EN96;

FIGS. 5a to 5d are graphic diagrams showing the degree of biodegradation by the novel microbial strain EN3 of Example 25 as a function of time (day) at initial diesel oil concentrations of 1,000 ppm, 5,000 ppm, 10,000 ppm and 20,000 ppm, respectively;

FIGS. 6a to 6d are graphic diagrams showing the degrees of biodegradation by the novel microbial strain EN67 of Example 26 as a function of time (day) at initial diesel oil concentrations of 1,000 ppm, 5,000 ppm, 10,000 ppm and 20,000 ppm, respectively;

FIGS. 7a to 7d are graphic diagrams showing the degrees of biodegradation by the novel microbial strain EN96 of Example 27 as a function of time (day) at initial diesel oil concentrations of 1,000 ppm, 5,000 ppm, 10,000 ppm and 20,000 ppm, respectively;

FIG. 8 is a graphic diagram showing the degrees of biodegradation by Gordonia nitida NP1 of Example 29 as a function of time (day) at initial diesel oil concentrations of 1,000 ppm, 5,000 ppm, 10,000 ppm and 20,000 ppm, respectively;

FIG. 9 is a graphic diagram showing an increase in the diesel oil biodegradability by the novel microbial strain EN3 of Example 30, caused by synthetic biosurfactant 2-hexyl-3-hydroxy-decanoic acid, at an initial diesel concentration of 20,000 ppm;

FIG. 10 is a graphic diagram showing an increase in the novel microbial strain NP1's diesel oil biodegradability of Example 31, caused by synthetic biosurfactant 2-hexyl-3-hydroxy-decanoic acid, at an initial diesel concentration of 15,000 ppm;

FIG. 11 is a graphic diagram showing an increase in the diesel oil biodegradability of microbial strain NP1 of Example 32, caused by synthetic biosurfactant 2-hexyl-3-hydroxy-decanoic acid, at an initial diesel concentration of 20,000 ppm; and

FIG. 12 is a graphic diagram showing the results of evaluation for the emulsification activities of biosurfactant 2-hexyl-3-hydroxy-decanoic acid for n-tetradecane and cyclohexane at surfactant concentrations of 10 ppm, 100 ppm and 1,000 ppm.

### DETAILED DESCRIPTION OF THE INVENTION

Rhodococcus baikoneurensis EN3, Acinetobacter johnsonii EN67 and Acinetobacter haemolyticus EN96, which are novel microbial strains according to the present invention, were isolated from soils which have been contaminated with various types of oil over a long period of time in the Kyungki-do province of Korea. The novel microbial strain Rhodococcus baikoneurensis EN3 is a gram-positive coccus or bacillus, the Acinetobacter johnsonii EN67 and the Acinetobacter haemolyticus EN96 are gram-positive cocci. These microbial strains have excellent biodegradability for various oil spectra.

The base sequences of 16S rRNA genes for the identification and classification of the novel microbial strain Rhodococcus baikoneurensis EN3, Acinetobacter johnsonii EN67 and Acinetobacter haemolyticus EN96, isolated according to the present invention, are shown in the accompanying SEQ ID NOS: 1 to 3, respectively, and showed a homology of 99% to Rhodococcus baikoneurensis DSM44587^{T}, Acinetobacter johnsonii ATCC 17909^{T} and Acinetobacter haemolyticus ATCC17906^{T}, respectively.

Said novel microbial strains classified according to the present invention were named “Rhodococcus baikoneurensis EN3”, “Acinetobacter johnsonii EN67” and “Acinetobacter haemolyticus EN96”, respectively, and were deposited in the Korean Collection for Type Cultures (KCTC) under accession numbers KCTC 19082, KCTC 12360 and KCTC 12361, respectively, on Dec. 8, 2004.

Thus, the novel strains according to the present invention are specified as “Rhodococcus baikoneurensis EN3 KCTC19082”, “Acinetobacter johnsonii EN67 KCTC12360”, and “Acinetobacter haemolyticus EN96 KCTC12361”, respectively.

The morphological, physiological and biochemical characteristics of the Rhodococcus baikoneurensis EN3 KCTC19082 according to the present invention are shown in Table 1 below.

TABLE 1
Morphological, physiological and biochemical
characteristics of Rhodococcus baikoneurensis EN3 KCTC19082

| Morphological, physiological and | Rhodococcus baikoneurensis |
|---|---|
| biochemical characteristics | EN3 KCTC19082 |
| Gram staining | + |
| Morphology | Rod/cocci |
| Optimal growth temperature ° C. | 30 |
| Nitrate reduction | − |
| Production of indole | − |

Enzyme activities

| | |
|---|---|
| N-Acetyl-β-glucosaminidase | − |
| Acid phosphatase | + |
| Alkaline phosphatase | + |
| α-Chymotrypsin | + |
| Esterase (C4) | + |
| Esterase Lipase (C8) | + |
| α-Fucosidase | − |
| α-Galactosidase | − |
| A-Glucosidase (starch hydrolysis) | + |
| β-Galactosidase (PNPG) | − |
| B-Glucosidase (esculin hydrolysis) | + |
| Lipase (C14) | + |
| Protease (gelatin hydrolysis) | − |
| Trypsin | + |
| Urease | + |

Assimilation

| | |
|---|---|
| 2-Ketogluconate | − |
| 3-Hydroxybenzoate | − |
| 3-Hydroxybutyrate | + |
| Acetate | + |
| Adipate | + |
| Caprate | − |
| Citrate | + |
| Gluconate | + |
| Malate | + |
| D-Glucose | − |
| Maltose | − |
| D-Ribose | + |
| D-Sucrose | + |
| L-Histidine | + |
| N-Acetylglucosamine | + |
| Glycogen | − |

+: positive reaction; and
−: negative reaction

The morphological, physiological and biochemical characteristics of Acinetobacter johnsonii EN67 KCTC12360 and Acinetobacter haemolyticus EN96 KCTC12361 according to the present invention are shown in Table 2 below.

TABLE 2
Morphological, physiological and biochemical
characteristics of Acinetobacter johnsonii EN67 KCTC12360
and Acinetobacter haemolyticus EN96 KCTC12361

| | Acinetobacter | Acinetobacter |
|---|---|---|
| Morphological, physiological | johnsonii | haemolyticus |
| and biochemical characteristics | EN67 KCTC12360 | EN96 |
| Gram staining | − | − |
| Morphology | cocci | cocci |
| Optimal growth temperature (° C.) | 30 | 30 |
| Nitrate reduction) | − | − |
| Production of indole) | − | − |

Enzyme activities

| | | |
|---|---|---|
| NAcetyl-β-glucosaminidase | − | − |
| Acid phosphatase | + | + |
| Alkaline phosphatase | + | − |
| α-Chymotrypsin | − | − |
| Esterase (C4) | + | + |
| Esterase Lipase (C8) | + | + |
| Valine arylamidase | − | − |
| α-Fucosidase | − | − |
| α-Galactosidase | − | − |
| A-Glucosidase (starch hydrolysis) | − | − |
| β-Galactosidase (PNPG) | − | − |
| β-Glucosidase (esculin hydrolysis) | − | − |
| Lipase (C14) | + | − |
| Protease (gelatin hydrolysis) | + | + |
| Trypsin | − | − |
| Urease | − | − |

Assimilation

| | | |
|---|---|---|
| 4-Hydroxybenzoate | − | + |
| 5-Ketogluconate | − | − |
| Acetate | − | + |
| Propionate | − | + |
| Valerate | − | + |
| Adipate | − | − |
| Caprate | − | + |
| Citrate | − | + |
| Malate | − | + |
| L-Alanine | − | + |
| L-Histidine | − | + |
| L-proline | − | + |
| N-Acetylglucosamine | − | − |
| Glycogen | − | − |

+: positive reaction; and
−: negative reaction

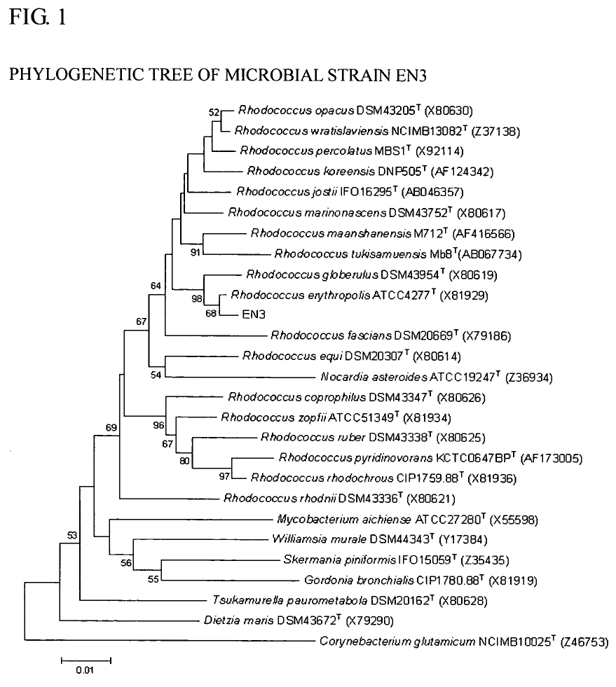

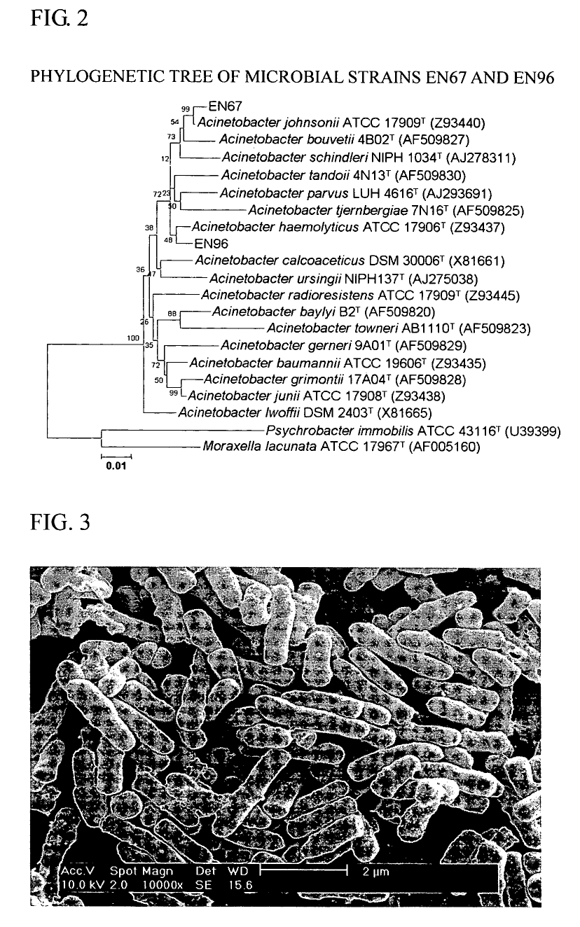

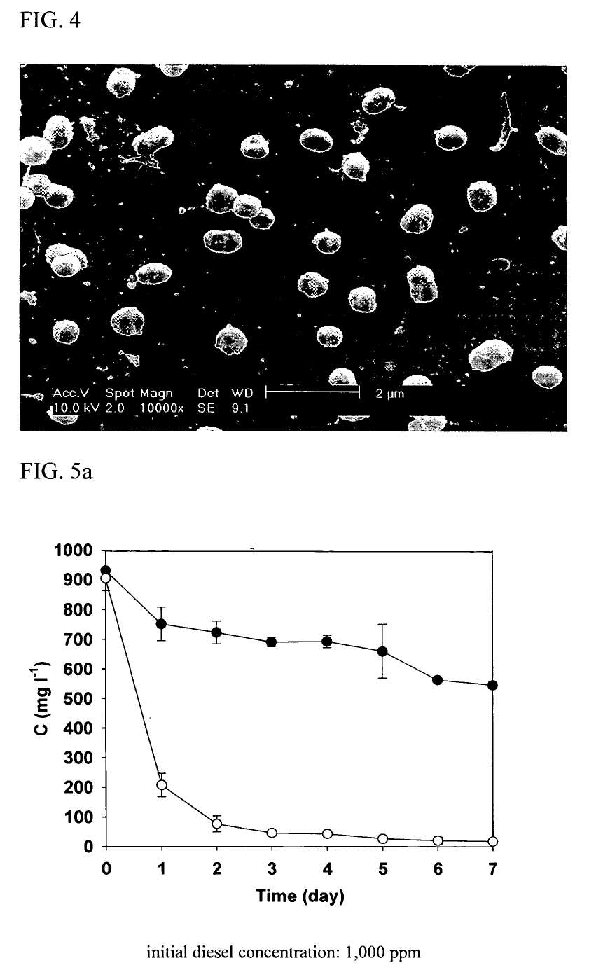

A phylogenetic tree of Rhodococcus baikoneurensis EN3 KCTC19082, the novel microbial strain according to the present invention, is shown in FIG. 1, and a phylogenetic tree of Acinetobacter johnsonii EN67 KCTC12360 and Acinetobacter haemolyticus EN96 KCTC12361, which are the novel strains according to the present invention, is shown in FIG. 2. A scanning electron microscope photograph of the Rhodococcus baikoneurensis EN3 KCTC19082 strain is shown in FIG. 3, and a scanning electron microscope photograph of the Acinetobacter haemolyticus EN96 KCTC12361 strain is shown in FIG. 4.

Microorganisms, which can be used in the inventive method for the bioremediation of oil-contaminated soils, are not limited to said novel microorganisms, and any microorganisms can be used in any particular limitation as long as they have having excellent oil biodegradability.

Such microorganisms include those having biodegradability for various oil contaminants isolated from soils, which have been contaminated with oils over a long period of time.

More specifically, Nocardia sp., Gordonia sp., Rhodococcus sp. and Acinetobactor sp. microorganisms can be used, and microorganisms belonging to these species have excellent biodegradability for various poorly-degradable substances such as diesel oil, bunker C oil, high-boiling-point aromatic compounds, chlorine compounds and the like. Also, such microorganisms are widely present in nature and degrade various contaminants as carbon sources and energy sources.

Specific examples of microbial strains, which were found to be capable of being used in the bioremediation of oil-contaminated soils by present invention, include Rhodococcus baikoneurensis EN3, Acinetobacter johnsonii EN67, and Acinetobacter haemolyticus EN96, which are the novel microbial strains, as well as Nocardia transvalensis DSM43405^{T} (hereinafter, depository authority and accession number), Nocardia asteroides ATCC19247^{T}, Gordonia sputi DSM43896^{T}, Gordonia rhizosphera IFO16068^{T}, Gordonia nitida LE31^{T}, Gordonia hirsuta DSM44140^{T}, Gordonia bronchialis CIP1780.88^{T}, Gordonia amarae DSM43392^{T}, Gordonia desulfuricans NCIMB40816^{T}, Rhodococcus zopfii ATCC51349^{T}, Rhodococcus wratislaviensis NCIMB13082^{T}, Rhodococcus tukisamuensis Mb8^{T}, Rhodococcus ruber DSM43338^{T}, Rhodococcus rhodochrous CIP1759.88^{T}, Rhodococcus rhodnii DSM43336^{T}, Rhodococcus pyridinovorans KCTC0647BP^{T}, Rhodococcus percolatus MBS1^{T}, Rhodococcus opacus DSM43205^{T}, Rhodococcus marinonascens DSM43752^{T}, Rhodococcus koreensis DNP505^{T} type2, Rhodococcus jostii IF016295^{T}, Rhodococcus globerulus DSM43954^{T}, Rhodococcus fascians DSM20669^{T}, Rhodococcus erythropolis ATCC4277^{T}, Rhodococcus erythreus DSM43066^{T}, Rhodococcus equi DSM20307^{T}, Rhodococcus coprophilus ATCC29080^{T}, Rhodococcus baikonurensis GTC 1041^{T}, Acinetobacter towneri AB1110^{T}, Acinetobacter baylyi B2^{T}, Acinetobacter calcoaceticus DSM30006^{T}, Acinetobacter grimontii 17A04^{T}, Acinetobacter lwoffii DSM2403^{T}, Acinetobacter radioresistens ATCC17909^{T}, Acinetobacter tandoii 4N13^{T}, Acinetobacter towneri AB1110^{T}, Acinetobacter baumannii ATCC19606^{T}, Acinetobacter bouvetii 4B02^{T}, Acinetobacter gerneri 9A01^{T}, Acinetobacter junii ATCC17908^{T}, Acinetobacter parvus LUH4616^{T}, Acinetobacter schindleri NIPH1034^{T}, Acinetobacter tjernbergiae 7N16^{T}, and Acinetobacter ursingii NIPH137^{T}. Although these microbial strains can also be used alone, these can preferably be used in suitable combinations with each other depending on needs (i.e., effective treatment according to the kind of contaminated oils, etc.).

The inventive method for the bioremediation of oil-contaminated soil comprises inoculating the oil-contaminated soil with at least one microbial strain selected from among the above-described microbial strains and proliferating the inoculated microbial strain so as to remove the oil from soil by biodegradation.

Said microbial strains all show a degradation rate of 100% at a diesel oil concentration of 1,000 ppm, and also show a degradation rate of more than 90% even at a diesel oil concentration of 20,000 ppm (see Table 3 below).

The inoculation level (including medium weight) of said microorganisms, which can be used in the inventive method for the bioremediation of oil-contaminated soil, is about 0.001-8% (v/v or v/w), and preferably about 0.1-3% (v/v or v/w), but is not limited thereto.

Also, in the inventive method for bioremediation of oil-contaminated soil, the biodegradation rate of oils can be significantly increased by about 20-70% by adding biosurfactant 2-alkyl-3-hydroxylic acid represented by Formula 1 below, or its derivative:

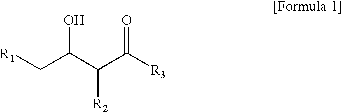

wherein R₁ and R₂ each independently represents a C4-C50 straight or branched-chain alkyl group including hydroxy, methoxy, keto, carbonyl, carboxy, epoxy, ester or a cyclopropane ring, and R₃ represents —OR₄, monoethanolamine, diethanolamine, D-glucosamine, glucamine, N-methylglucamine, glucose, ramnose, mannose, galactose, lactose, sucrose, maltose, arabinose, cellobiose, or polysaccharide including said monosaccharide or disaccharide, wherein R₄ represents hydrogen, sodium, potassium, magnesium, calcium, ammonium or triethanolamine.

Hereinafter, 2-alkyl-3-hydroxylic acid and its derivative, which can be effectively used in the inventive method for the bioremediation of oil-contaminated soil, will be described in detail.

Said compound can be synthesized through a reaction pathway as described below. The synthetic reaction according to the present invention consists of a two-step process comprising a step of hydrogenating an alkyl ketene dimer in the presence of a 5% Pd/C, 10% Pd/C or 0.5% Pd/Al₂O₃ catalyst in a hydrogen atmosphere to form β-lactone, and a step of either subjecting β-lactone to ring-opening reaction to prepare 2-alkyl-3-hydroxylic acid or allowing the β-lactone to react with sugar and a nucleophile to form a derivative of 2-alkyl-hydroxylic acid.

The alkyl ketene dimer has been widely used as a sizing agent for selectively preventing liquid from penetrating into paper in the papermaking industry. As the alkyl ketene dimer, commercially available compounds, for example, products available from BASF AG, Nippon Oil & Fat Co., Ltd., Hercules, Inc., etc., can be used in the present invention. Alternatively, it can also be synthesized by reacting acyl chloride with triethylamine to have the desired alkyl group and alkenyl group. The synthesis of the alkyl ketene dimmer is described in detail in several papers [J. Amer. Chem. Soc., 87, 5191 (1965)/ibid., 72, 1461 (1950)/ibid., 69, 2444 (1947)].

The alkyl ketene dimmer obtained as described above reacts with a 5% Pd/C, 10% Pd/C or 0.5% Pd/Al₂O₃ catalyst in a hydrogen atmosphere to form β-lactone, which is then converted into 2-alkyl-3-hydroxylic acid or its derivative by ring-opening reaction or a reaction with saccharide.

Hereinafter, a process for preparing said 2-alkyl-3-hydroxy fatty acid and its derivative will be described in detail with reference to Reaction Scheme 1 below.

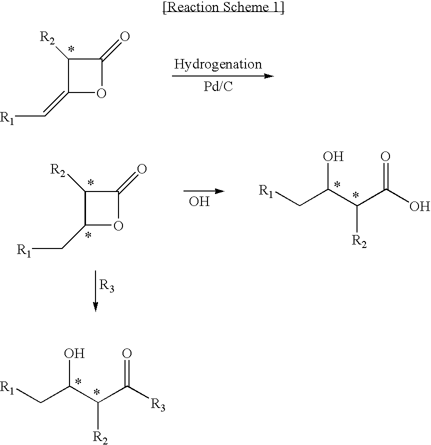

The first-step reaction in reaction scheme 1 above is a reaction of hydrogenating the alkyl ketene dimmer with a 5% Pd/C, 10% Pd/C or 0.5% Pd/Al₂O₃ catalyst in a hydrogen atmosphere to produce β-lactone, and the second-step reaction is a reaction of subjecting the β-lactone to ring-opening reaction in the presence of alkali or allowing the β-lactone to react with a nucleophile having sugar, thus making 2-alkyl-3-hydroxy fatty acid or its derivative.

For the hydrogenation in the first-step reaction according to the present invention, it is possible to use various catalysts known to be effective for hydrogenation. Examples of such catalysts may include a palladium-alumina complex (Pd/Al₂O₃), a ruthenium chloride (II)-2,2′-bis(diphenylphosphino)-1,1′-binaphthyl complex (RuCl(2,2′-bis(diphenylphosphino)-1,1′-binaphthyl)), Raney-Ni, a rhodium aluminum oxide complex (Rh/Al₂O₃), a palladium complex (Pd/BaSO₄, Pd/C), etc. Among said reaction catalysts, 5% Pd/C, 10% Pd/C and 0.5% Pd/Al₂O₃ catalysts, which are easily separated and purified, can preferably be used. Also, the amount of catalyst used is 0.01-4 wt % based on the weight of the alkyl ketene dimer. The preferred amounts of catalyst used is 0.05-1.0 wt % for 5% Pd/C, 0.025-0.5 wt % for 10% Pd/C, and 0.5-2 wt % for 0.5% Pd/Al₂O₃. Although the hydrogenation in the first-step reaction can also be carried out at high pressure, it is preferably conducted at about 1-50 atm, and more preferably about 2-40 atm. The 0.5% Pd/Al₂O₃ catalyst has advantages in that, because it is a supported catalyst which takes the form of a pellet, not a powder, unlike general catalysts, it is easy to separate after reaction, and it enables to obtain 2-alkyl-3-hydroxy-alkanoic β-lactone with high yield, even when it is recycled more than 10 times.

However, the reaction yield can be decreased due to the formation of 2-alkyl fatty acid caused by the ring opening reaction of the alkyl ketene dimer depending on parameters, including reaction time, a solvent used and reaction temperature. This side reaction can be confirmed by NMR, and it can be actually confirmed that 2-octyl-octanoic acid, 2-pentadecyl-pentadecanoic acid, etc. are formed from a C₈ alkyl ketene dimer, a C₁₆ alkyl ketene dimer, etc. [¹H-NMR CDCl₃, δ] 0.87 (t, 6H), 1.25-1.64 (m), 2.23-2.38 (m, 1H)]. Thus, in order to suppress these undesirable side reactions, it is important to suitably maintain the reaction conditions. For this purpose, it is preferable that the reaction be carried out between room temperature and 50° C., and be terminated just after the alkyl ketene dimer disappears as measured by thin layer chromatography (TLC). Particularly when a suitable mixed solvent selected depending on the carbon atom number of the alkyl ketene dimer is used, the side reactions will not occur and 2-alkyl-3-hydroxy-alkanoic acid β-lactone can be obtained with high yield without a special purification process.

Examples of a solvent, which can be used in the first step of reduction, may include methanol, ethanol, ethyl acetate, n-propanol, n-butanol, isopropanol, tetrahydrofuran, dimethylformamide, dimethylsulfoxide and the like. Preferred are methanol, ethanol and a mixed solvent thereof. The most preferable solvent for the first step reaction is a mixture of ethyl acetate and ethyl alcohol (5%:95%-95%:5% v/v).

In the ring-opening reaction of the second step, the β-lactone is ring-opened by reaction with a base, thus obtaining 2-alkyl-3-hydroxylic acid salt. Also, the obtained salt can be isolated in the presence of an organic solvent, and the isolated salt can be acidified and extracted, thus obtaining a high purity of 2-alkyl-3-hydroxylic acid.

It is possible to allow the β-lactone produced in the first step to react with a nucleophile to prepare a new derivative. If 2-alkyl-3-hydroxylic acid is substituted with sugar as a hydrophilic group, it is expected to have increased hydrophilicity and various surfactant abilities. Also, it is possible to prepare new derivatives using glucose, ramnose, mannose, galactose, lactose, sucrose, maltose, arabinose, cellobiose, saccharide including such monosaccharide or disaccharide, amine-containing sugar such as D-glucosamine, glucamine or N-methylglucamine, monoethanolamine or diethanolamine.

Said 2-alkyl-3-hydroxy fatty acid or its derivative can also be used as an effluent water treatment agent due to its excellent surfactant action and an eco-friendly property of low secondary contamination. Also, it has a relatively simple chemical structure, and thus is synthesized in an easy and economical manner.

The inventive method for the bioremediation of oil-contaminated soil may comprise isolating and identifying microbial strains by: a step of collecting soil contaminated with oils; a step of isolating oil-degrading microbial strains from the collected soil; a step of separately culturing a few hundred kinds of the isolated microbial strains; a first screening step of screening microbial strains having excellent oil biodegradability from the cultured microbial strains; and a second screening step of screening microbial strains, the ability of which to degrade a high concentration of oil contaminants is increased through the use of biosurfactants such as said 2-alkyl-3-hydroxy acid and its derivative, from said microbial strains screened in the first screening step.

The biosurfactants are 2-alkyl-hydroxy fatty acid and its derivative, secreted by microorganisms. These are present in the cell wall of acetmital microorganisms and function to facilitate the microbial use of oils by lowering the interfacial tension between microorganisms and oil carbon sources, such that the microorganisms can grow using oils as carbon sources in sites having a high concentration of oils. In the inventive bioremediation method, said biosurfactants serve to increase the ability of the identified and isolated microorganisms to biodegrade oil contaminants.

The biosurfactant 2-alkyl-3-hydroxylic acid or its derivative is used in an amount of 0.0001-10 wt %, and preferably 0.001-10 wt %, based on the total weight of the microbial strain and the medium.

Hereinafter, the identification, isolation and classification of said microbial strains, preparation methods of biosurfactant 2-alkyl-3-hydroxy fatty acid and its derivative, and oil biodegradation rates, will be described with reference to examples and comparative examples. It is to be understood, however, that these examples are for illustrative purposes only and are not to be construed to limit the scope of the present invention.

### EXAMPLE 1

Isolation of Microorganisms having Oil Degradation Activity

Soils, which have been contaminated with various types of oil over a long period of time in the Kyungki-do province of Korea, were used as inoculation samples. Oil-contaminated soils were collected from portions of 0-2 m depth from the ground surface, and then immediately placed into bottles and freeze-stored at 4° C. Specific information on the collection of the samples is shown in Table 3 below.

TABLE 3

| Collection | | Number of | |
|---|---|---|---|
| date | Collection site | samples | Contaminants |
| 15 Oct. | Oil reservoir, Inchon, Kyungki-do, Korea | 2 | Diesel oil, kerosene, bunker C oil |
| 2002 | | | |
| 15 Nov. | Oil reservoir, Inchon, Kyungki-do, Korea | 2 | Diesel oil, kerosene, bunker C oil |
| 2002 | | | |
| Dec. 15, | Oil reservoir, Inchon, Kyungki-do, Korea | 2 | Diesel oil, kerosene, bunker C oil |
| 2002 | | | |
| Oct. 17, | Wastewater of the Sihwa Lake, Kyungki- | 1 | Oil sludge |
| 2002 | do, Korea | | |

To screen microorganisms having excellent oil biodegradability, the samples were spread onto plate media consisting of LB (Luria-Bertani) agar media or tryptic soy agar media and were cultured at 30° C. for 48 hours. After the culture step, the formed single colonies were observed with a microscope, and 500 cocci and 500 bacilli were selected, spread again onto the plate media and then isolated. The isolated microbial strains were inoculated into liquid media containing 1,000 ppm, 5,000 ppm, 10,000 ppm and 20,000 ppm of diesel oil and mineral components (NH₄NO₃, 1 g/L; MgSO₄, 0.2 g/L; CaCl₂, 0.02 g/L; FeCl₂, 0.05 g/L; KH₂PO₄, 1 g/L; K₂HPO₄, 1 g/L; pH 7.0) in triangular flasks, and then cultured at 30° C. for 7 days.

Identification of Isolated Microorganisms

Three microbial strains showing the most excellent growth in the liquid media containing diesel oil and mineral components were selected and subjected to microbial identification. For the identification of the isolated strains, the base sequences of the 16S rRNA genes were analyzed. For this purpose, the strains were first cultured in MRS broths (Difco) for 7 days with shaking at 30° C. and 150 rpm. To collect microbial cells from the culture media, the media were centrifuged at 6,000 rpm for 20 minutes, and microbial cells at the lower layer were collected. Following this, the chromosomal DNA of the cells was extracted and purified using the DNeasy Tissue Kit (Qiagen). 16S rRNA genes were amplified by PCR using the chromosomal DNA as a template.

Then, the phylogenetic positions of the isolated EN3, EN67 and EN96 strains were analyzed. For the phylogenetic analysis, the full sequences of the amplified 16S rRNA genes of the EN3, EN67 and EN96 strains were analyzed using SeqMan software, BioEdit program and CLUSTAL X program, and then the related sequences of associated strains were searched in the GenBank database using the BLAST search program. Then, the distance matrix between the sequences was analyzed using the BioEdit program, and a phylogenetic tree for the EN-3 strain was completed using the Mega2 program according to the neighbor-joining method.

The base sequence of the 16S rRNA gene of the novel microbial strain EN3 is shown in SEQ ID NO: 1, and the base sequences of the 16S rRNA genes of the novel microbial strains EN67 and EN96 are shown in SEQ ID NOS: 2 and 3, respectively.

In addition, FIG. 1 shows the phylogenetic tree of the novel microbial strain EN3, and FIG. 2 shows the phylogenetic tree of the novel microbial strains EN67 and EN96.

After analyzing the base sequences of the amplified genes, the classification of the novel isolated strains was performed using the MEGA version 2.1 program. As a result, the isolated strains were identified as novel microorganisms. Also, the morphological, physiological and biochemical characteristics of the novel microbial strains were analyzed, and the analysis results are shown in Tables 1 and 2 above.

Also, the scanning electron microscope (SEM) photographs (X10,000) of the novel strains EN3 and EN96 cultured in TSA media to the exponential-growth phase for the morphological observation of the strains are shown in FIGS. 3 and 4, respectively.

### EXAMPLES 2-12 AND COMPARATIVE EXAMPLES 1-6

Measurement of Oil Contaminant Degradation Activity of Isolated Microorganisms

Diesel oil used in this experiment was purchased from GS-Caltex Oil Corporation (Taejon, Korea), and composed of 42.7% alkanes, 33.4% cycloalkanes and 23.9% aromatics. Numerical values shown on a technical data sheet obtained from GS-Caltex Oil Corporation were recorded.

In the experiment, 100 ml of mineral media (NH₄NO₃, 1 g/L; MgSO₄, 0.2 g/L; CaCl₂, 0.02 g/L; FeCl₂, 0.05 g/L; K₂HPO₄, 1 g/L; KH₂PO₄, 1 g/L; pH 7.0) containing no carbon and energy sources were added to 500-ml flasks, to which 100, 500, 1000, 1500 and 2000 mg of diesel oil were then added. Thereafter, each of the strains cultured in tryptic soy agar media (Difco) was inoculated into the flasks, which were then sealed with polytetrafluoroethylene. Herein, each of the microbial strains was inoculated at a concentration of 6×10⁶ cfu/ml to a final concentration ratio of 1% (v/v) and then adjusted to pH 6.9-7.1. Thus, the diesel oil was the sole carbon/energy source, and the microorganisms would degrade the diesel oil during the growth thereof. Also, for use as a control group in this experiment, a diesel oil-containing mineral salt medium non-inoculated with the strains was cultured and measured for TPH, in order to compensate a reduction in the concentration of the diesel oil, caused by the volatilization of low-boiling-point compounds among various compounds contained in the diesel oil, with the passage of time. Also, to prevent the error of measurement, three samples were measured and the average of the measurements was recorded, and to minimize the amount of diesel oil, which would be attached to the flasks and thus not measured, the sample contained in each of the flasks was measured after extracting it with 100 ml of normal hexane. The microbial strains were cultured at 30° C. and 300 rpm for 7 days, sampled at one-day intervals and measured for diesel oil degradation rate by gas chromatography.

In the analysis of the diesel oil, gas chromatography (HP 5890 series II, Hewlett-Packard, USA) equipped with FID detector (HP 5890 series II, Hewlett-Packard, USA), and an HP-1 column (30 m×0.32 mm×1 μm, J&W Scientific, USA), were used, helium was used as a carrier gas, and an injector and a detector were set at 280° C. and 300° C. The temperature of the column was maintained at 40° C. for 2 minutes, elevated to 300° C. at a rate of 10° C./min, and then maintained at 300° C. for 15 minutes. In this experiment, 2 μl of each of the samples was injected and the amount of remaining diesel oil was measured as the total of all the peak areas of the gas chromatogram, i.e., TPH (total petroleum hydrocarbon). The extraction of the remaining oil contaminants was performed using N-hexane, and degradation rate (%) was calculated according to equation 1 below.

Degradation rate (%)=TPH area of microorganism-inoculated group/TPH area of uninoculated group×100 [Equation ]

The results of oil biodegradability tests for the microbial strains, isolated and obtained by the present inventors, are shown in Table 4 below.

TABLE 4

| | | | Degradation rates (%) at initial | | | |
|---|---|---|---|---|---|---|
| | | | diesel concentrations | | | |
| | | Strain names | 1000 ppm | 5000 ppm | 10,000 ppm | 20,000 ppm |
| Comparative | 1 | Pseudomonas aeruginosa | 60.58 | 50.13 | 11.56 | 0.00 |
| Examples | 2 | Klebsiella pneumonia | 78.71 | 61.00 | 21.73 | 0.00 |
| | 3 | Bacillus subtilis | 57.45 | 51.78 | 33.76 | 0.00 |
| | 4 | Streptomyces speibonae | 61.43 | 53.67 | 27.39 | 0.00 |
| | 5 | Bacillus pumilus | 63.59 | 50.13 | 14.67 | 0.00 |
| | 6 | Bacillus licheniformis | 21.11 | 11.36 | 9.01 | 0.00 |
| Examples | 2 | Rodococcus baikoneurensis EN3 | 100.00 | 64.90 | 60.70 | 30.50 |
| | 3 | Acinetobacter johnsonii EN67 | 100.00 | 94.50 | 94.60 | 93.60 |
| | 4 | Acinetobacter haemolyticus EN96 | 100.00 | 97.70 | 90.80 | 91.40 |
| | 5 | Acinetobacter junii EN105 | 100.00 | 82.78 | 50.20 | 17.34 |
| | 6 | Gordonia nitida NP1 | 100.00 | 90.70 | 75.90 | 55.87 |
| | 7 | Gordonia amicalis NP2 | 100.00 | 92.12 | 88.14 | 32.70 |
| | 8 | Gordonia desulfuricans NP3 | 100.00 | 85.28 | 82.21 | 65.85 |
| | 9 | Gordonia SRP2 NP4 | 100.00 | 93.88 | 92.36 | 87.53 |
| | 10 | Gordonia westfalica NP6 | 100.00 | 84.06 | 81.37 | 37.77 |
| | 11 | Gordonia namibiensis NP7 | 100.00 | 82.83 | 32.41 | 19.39 |
| | 12 | Mixed cultured strain of Examples | 100.00 | 97.36 | 93.88 | 93.23 |
| | | 2, 6 and 7 | | | | |

As can be seen in Table 4 above, Pseudomonas aeruginosa of Comparative Example 1, Klebsiella pneumonia of Comparative Example 2, Bacillus subtilis of Comparative Example 3, Streptomyces speibonae of Comparative Example 4, Bacillus pumilus of Comparative Example 6, and Bacillus licheniforimis of Comparative Example 6, all showed an oil degradation rate of 50-60% on the average at initial diesel concentrations of 1000 ppm and 5000 ppm, and an oil degradation rate of 10-20% on the average at an initial diesel concentration of 10,000 ppm, and did not show diesel degradation at an initial diesel concentration of 20,000 ppm. Particularly, Bacillus licheniformis of Comparative Example 6 showed a degradation rate of 10% on the average at initial diesel concentrations of 1000 ppm and 5000 ppm, suggesting that the oil degradation ability thereof was very low.

Meanwhile, Rodococcus baikoneurensis EN3 of Example 2, Acinetobacter johnsonii EN67 of Example 3, Acinetobacter haemolyticus EN96 of Example 4, Acinetobacter junii EN105 of Example 5, Gordonia nitida NP1 of Example 6, Gordonia amicalis NP2 of Example 7, Gordonia desulfuricans NP3 of Example 8, Gordonia SPR2 NP4 of Example 9, Gordonia westfalica NP6 of Example 10, Gordonia namibiensis NP-7 of Example 11, and the mixed strain of Example 12, had an excellent degradability of 82-100% at initial diesel concentrations of 1,000 ppm and 5,000 ppm, but the oil degradability thereof was relatively reduced at initial diesel concentrations of 10,000 ppm and 20,000 ppm. However, the mixed cultured strain of Example 12, consisting of a mixture of Example 2, Example 6 and Example 7, showed an increase in diesel oil degradability at initial diesel concentrations of 10,000 ppm and 20,000 ppm, compared to those of the individual strains.

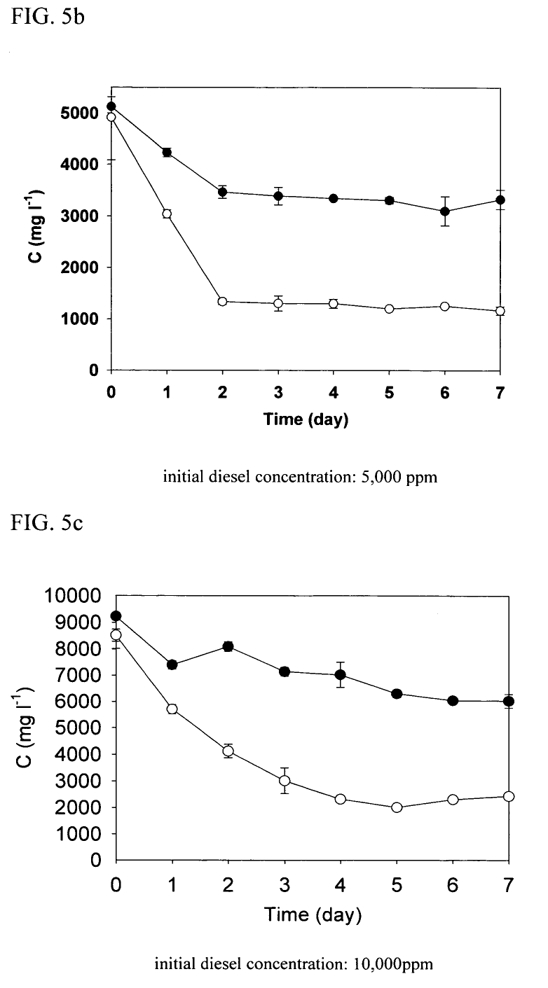

The results of diesel oil degradation tests for Rodococcus baikoneurensis EN3-inoculated media and uninoculated media, conducted at initial diesel concentrations of 1000 ppm, 5000 ppm, 10,000 ppm and 20,000 ppm, are shown in FIGS. 5a to 5d, respectively.

In FIGS. 5a to 5d, the initial inoculation level of Rhodococcus baikonurensis EN3 is 6×10⁴ cfu/ml, the symbol “•” indicates a microorganism-uninoculated group (control group), and the symbol “∘” indicates a microorganism-inoculated group.

As can be seen in FIGS. 5a to 5d, at 7 days after inoculation of the microbial strain, the Rhodococcus baikonurensis EN3-inoculated group showed a degradation rate of 100% at an initial diesel concentration of 1000 ppm, and the degradation rate was reduced to 64.9% and 60.7% at 5,000 ppm and 10,000 ppm. At 20,000 ppm, it showed a low degradation of 30.5%. The degradation of the diesel oil progressed mainly up to 3 days after the inoculation, and then reduced at 4-7 days after the inoculation.

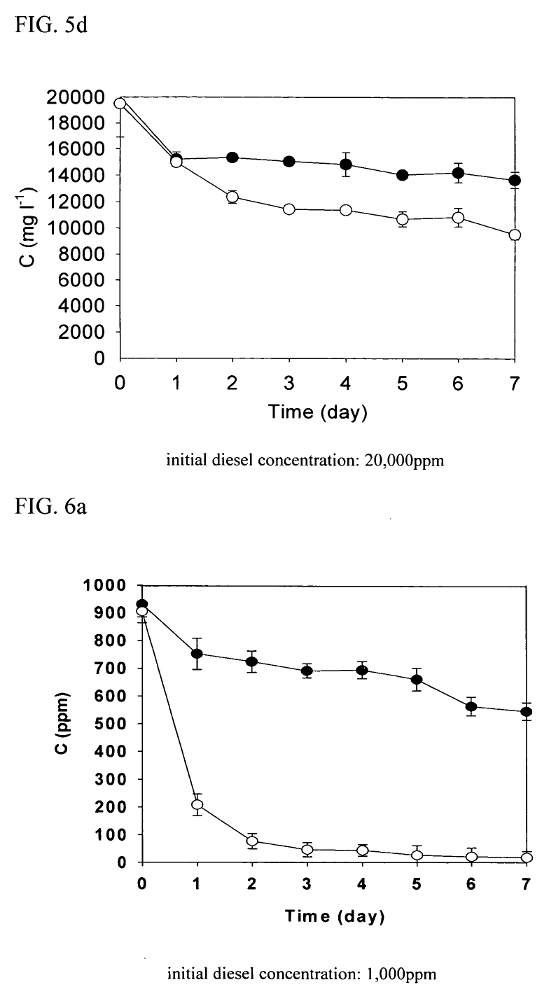

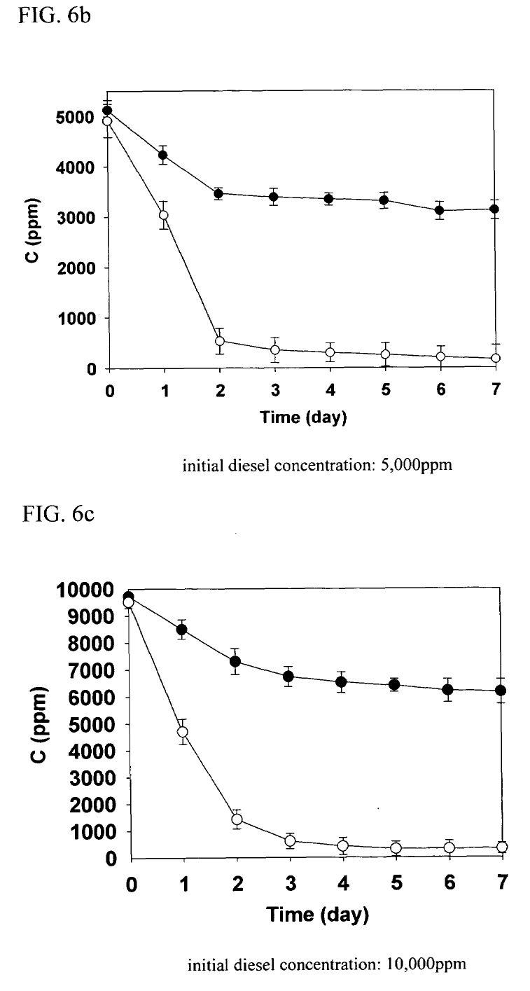

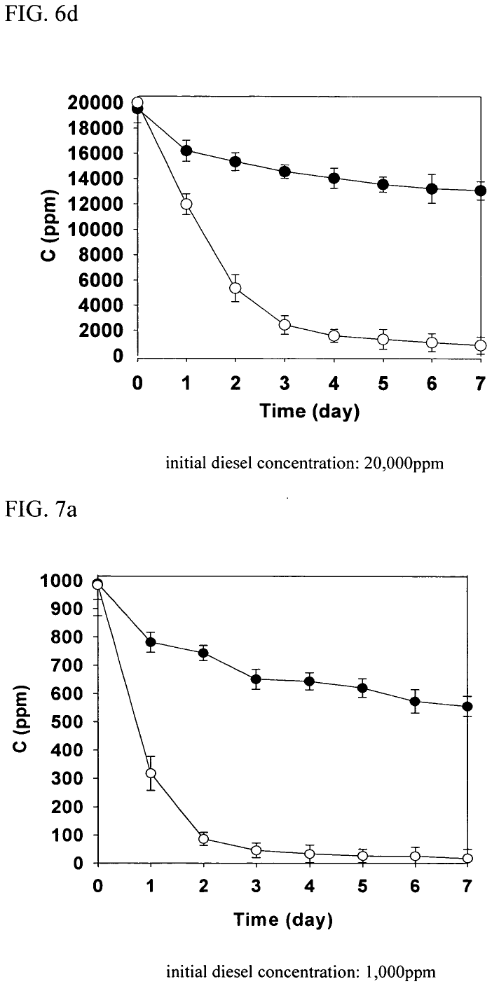

Meanwhile, the results of diesel oil degradation tests for Acinetobacter johnsonii EN67-inoculated media and uninoculated media, conducted at initial diesel concentrations 1000 ppm, 5000 ppm, 10,000 ppm and 20,000 ppm, are shown in FIGS. 6a to 6d, respectively.

In FIGS. 6a to 6d, the initial inoculation level of Acinetobacter johnsonii EN67 is 6×10⁴ cfu/ml, the symbol “•” indicates a microorganism-uninoculated group (control group), and the symbol “∘” indicates a microorganism-inoculated group.

As can be seen in FIGS. 6a to 6d, at 7 days after inoculation of the microbial strain, the Acinetobacter johnsonii EN67-inoculated group showed a degradation rate of 100% at an initial diesel concentration of 1000 ppm, and also showed high degradation rates of 94.5%, 94.6% and 93.6% even at 5000 ppm, 10,000 ppm and 20,000 ppm, respectively. The degradation of the diesel oil mainly continued during up to 3 days after the inoculation, and then reduced at 4-7 days after the inoculation.

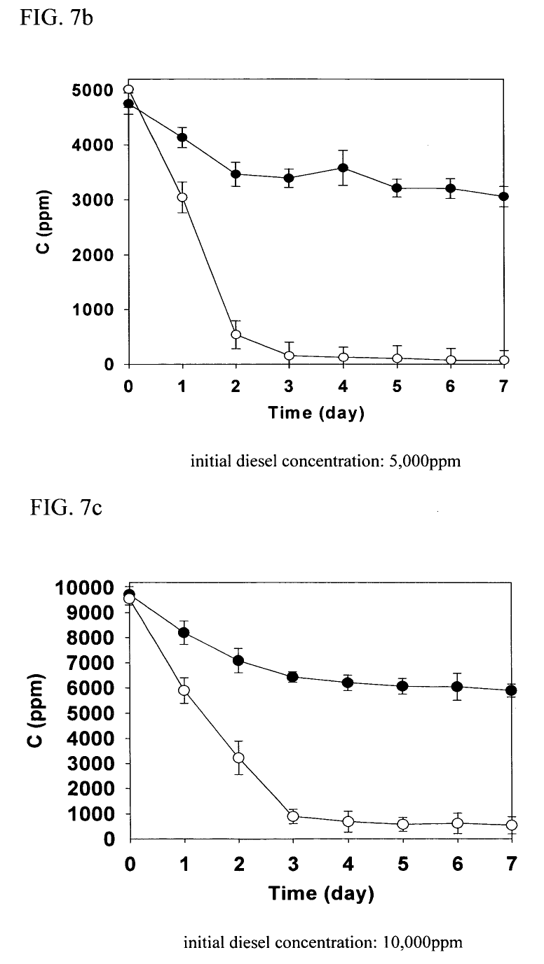

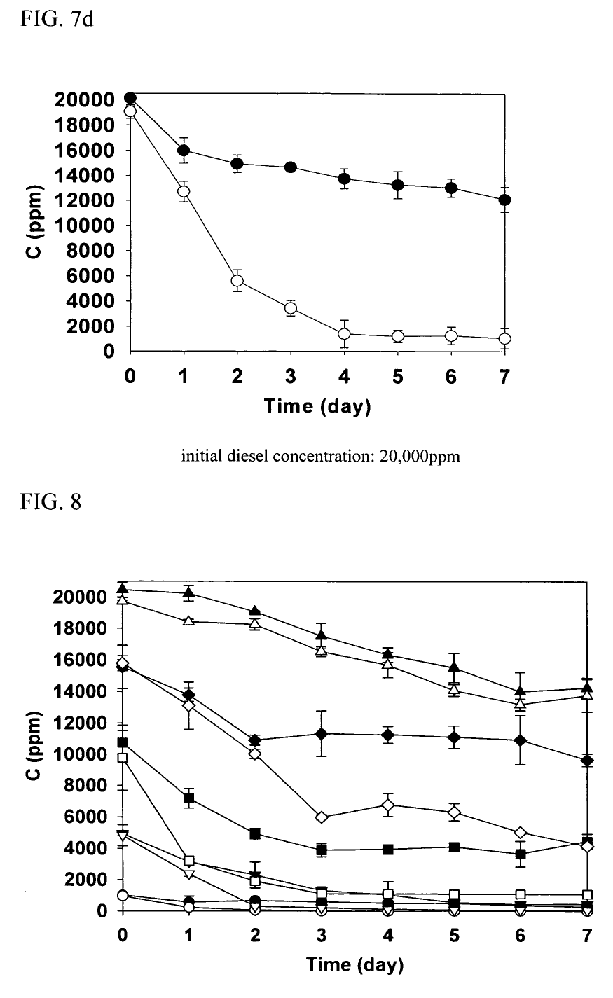

Meanwhile, the results of diesel oil degradation tests for Acinetobacter haemolyticus EN96-inoculated media and uninoculated media, conducted at initial diesel concentrations of 1000 ppm, 5000 ppm, 10,000 ppm and 20,000 ppm, are shown in FIGS. 7a to 7d, respectively.

In FIGS. 7a to 7d, the initial inoculation level of Acinetobacter haemolyticus EN96 is 6×10⁴ cfu/ml, the symbol “•” indicates a microorganism-uninoculated group (control group), and the symbol “∘” indicates a microorganism-inoculated group.

As can be seen in FIGS. 7a to 7d, at 7 days after inoculation of the microbial strain, the Acinetobacter johnsonii EN96-inoculated group showed a degradation rate of 100% at an initial diesel concentration of 1000 ppm, and also showed high degradation rates of 97.7%, 90.8% and 91.4% even at 5000 ppm, 10,000 ppm and 20,000 ppm, respectively. The degradation of the diesel oil mainly continued during up to 3 days after the inoculation, and then reduced at 4-7 days after the inoculation.

Meanwhile, the results of diesel oil degradation tests for Gordonia nitida NP1-inoculated media and uninoculated media, conducted at initial diesel concentrations of 1000 ppm, 5000 ppm, 10,000 ppm, 15,000 ppm and 20,000 ppm, are shown in FIG. 8.

In FIG. 8, the initial inoculation level of Gordonia nitida NP1 is 6×10⁴ cfu/ml, the initial diesel concentrations of the microorganism-uninoculated group are shown as 1000 ppm (∘), 5000 ppm (∇), 10,000 ppm (□), 15,000 ppm (⋄) and 20,000 ppm (Δ), and the initial diesel concentrations of the microorganism-inoculated group are shown as 1000 ppm (), 5000 ppm (▾), 10,000 ppm (▪), 15,000 ppm (♦) and 20,000 ppm (▴).

As can be seen in FIG. 8, at 7 days after inoculation of the microbial strain, the Gordonia nitida NP1-inoculated group showed a degradation rate of 100% at an initial diesel concentration of 1000 ppm, and also degradation rates of 90.7%, 75.9% and 56.8% even at 5000 ppm, 10,000 ppm and 15,000 ppm, respectively. At an initial diesel concentration of 20,000 ppm, the degradation rate was remarkably reduced to less than 20%. The degradation of the diesel oil mainly continued during up to 3 days after the inoculation, and then reduced at 4-7 days after the inoculation.

### EXAMPLES 13-15

Measurement of Biosurfactant's Ability to Increase Oil Degradation Activity of Microorganisms

In the cases of Rodococcus baikoneurensis EN3 of Example 2, Acinetobacter junii EN105 of Example 5, Gordonia nitida NP1 of Example 6, Gordonia amicalis NP2 of Example 7, Gordonia desulfuricans NP3 of Example 8, Gordonia westfalica NP6 of Example 10, and Gordonia namibiensis NP7 of Example 11, except for Acinetobacter johnsonii EN67 of Example 3, Acinetobacter haemolyticus EN96 of Example 4 and Gordonia SPR2 NP4 of Example 9, the oil biodegradability of the microorganisms was reduced at high diesel oil concentrations of more than 10,000 ppm.

For this reason, 2-hexyl-3-hydroxy-decanoic acid having 16 carbon atoms according to the present invention was added liquid media each containing 10,000 ppm or 20,000 ppm of diesel oil and mineral medium (NH₄NO₃, 1 g/L; MgSO₄, 0.2 g/L; CaCl₂, 0.02 g/L; FeCl₂, 0.05 g/L; KH₂PO₄, 1 g/L; K₂HPO₄, 1 g/L; pH 7.0). Then, the media were inoculated with each of Rodococcus baikoneurensis EN3 of Example 2 and Gordonia nitida NP1 of Example 6 and cultured at 30° C. for 7 days. Then, an increase in the oil biodegradability of each of the microbial strains was measured using gas chromatography.

### EXAMPLE 13

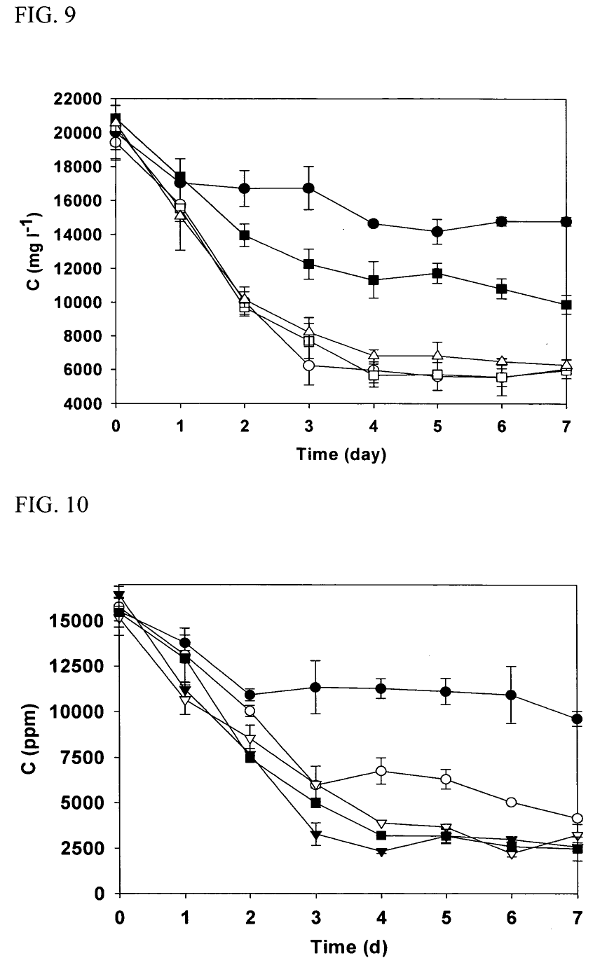

FIG. 9 is a graphic diagram showing an increase in the diesel oil degradability of Rodococcus baikoneurensis EN3, caused by the synthetic biosurfactant 2-hexyl-3-hydroxy-decanoic acid, at an initial diesel concentration of 20,000 ppm. In FIG. 9, the initial inoculation level of Rodococcus baikoneurensis EN3 is 6×10⁴ cfu/ml, and the initial concentration of diesel oil is 20,000 ppm. Also, the initial concentrations of 2-hexyl-3-hydroxy-decanoic acid are 10 ppm (∘), 50 ppm (□) and 100 ppm (Δ), the symbol “•” indicates a microorganism-uninoculated group (control group 1), and the symbol “▪” indicates a group (control group 2), which was inoculated with microorganisms, but not injected with 2-hexyl-3-hydroxy-decanoic acid.

The critical micelle concentration (cmc) of 2-hexyl-3-hydroxy-decanoic acid was 37.1 ppm, and the concentrations of 2-hexyl-3-hydroxy-decanoic acid were 10 ppm, 50 ppm and 100 ppm, respectively. At all the acid concentrations, the microbial strain showed an oil biodegradation rate of about 70%, which was increased compared to about 30%, which was the biodegradation rate in the case in which 2-hexyl-3-hydroxy-decanoic acid was not added. Also, regardless of a change in the concentration of 2-hexyl-3-hydroxy-decanoic acid, the highest values of degradation of diesel oil were approximately the same.

### EXAMPLE 14

FIG. 10 is a graphic diagram showing an increase in the diesel oil degradability of Gordonia nitida NP1, caused by the synthetic biosurfactant 2-hexyl-3-hydroxy-decanoic acid, at an initial diesel concentration of 15,000 ppm. In FIG. 10, the initial inoculation level of Rodococcus baikoneurensis EN3 is 6×10⁴ cfu/ml, and the initial concentration of diesel oil is 15,000 ppm. Also, the initial concentrations of 2-hexyl-3-hydroxy-decanoic acid were 9 ppm (▾), 90 ppm (∇) and 900 ppm (▪), the symbol “” indicates a microorganism-uninoculated group (control group 1), and the symbol “∘” indicates a group (control group 2), which was inoculated with microorganisms, but not injected with 2-hexyl-3-hydroxy-decanoic acid.

### EXAMPLE 15

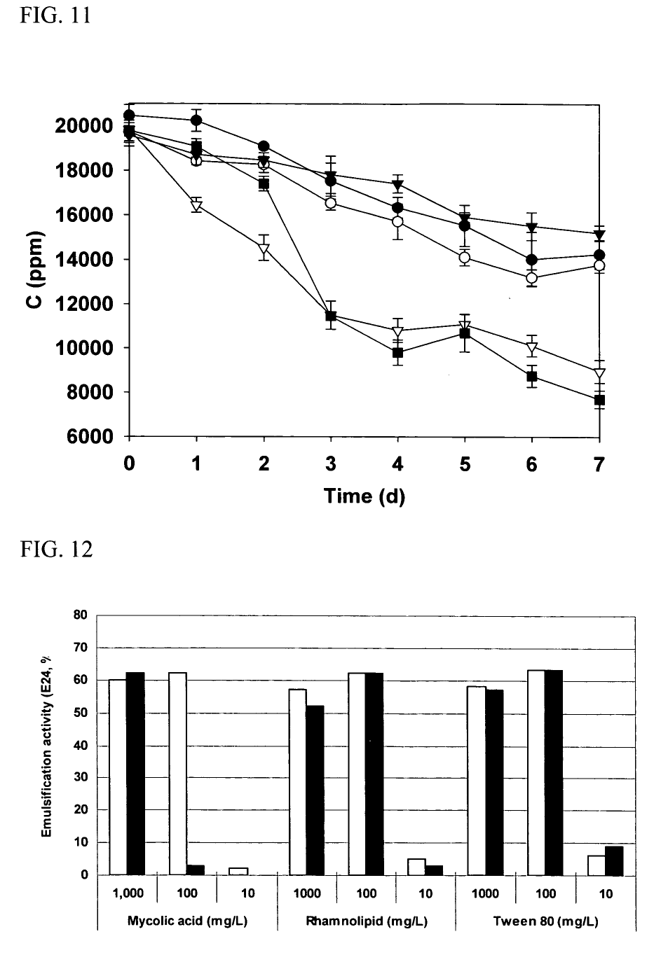

FIG. 11 is a graphic diagram showing an increase in the diesel oil degradability of Gordonia nitida NP1, caused by the synthetic biosurfactant 2-hexyl-3-hydroxy-decanoic acid, at an initial diesel concentration of 20,000 ppm. In FIG. 11, the initial inoculation level of Rodococcus baikoneurensis EN3 is 6×10⁴ cfu/ml, and the initial concentration of diesel oil is 20,000 ppm. Also, the initial concentrations of 2-hexyl-3-hydroxy-decanoic acid were 9 ppm (▾), 90 ppm (∇) and 900 ppm (▪), the symbol “500 ” indicates a microorganism-uninoculated group (control group 1), and the symbol “∘” indicates a group (control group 2), which was inoculated with microorganisms, but not injected with 2-hexyl-3-hydroxy-decanoic acid.

The concentrations of 2-hexyl-3-hydroxy-decanoic acid were 9 ppm, 90 ppm and 900 ppm. At all the acid concentrations, the microbial strain showed a great increase in its diesel oil degradation rate, but did not show an increase in the oil degradation rate at an initial diesel oil concentration of 20,000 ppm and a concentration of 2-hexyl-3-hydroxy-decanoic acid of 9 ppm. However, at concentrations of 2-hexyl-3-hydroxy-decanoic acid of 90 ppm and 900 ppm, the highest values of degradation of diesel oil were approximately the same, regardless of changes in the concentration.

### EXAMPLES 16 AND 17 AND COMPARATIVE EXAMPLES 7-10

Microbial Growth Promotion of Biosurfactant 2-hexyl-3-hydroxy-decanoic Acid

These examples relate to an experiment of confirming whether the growth of microorganisms having oil biodegradability is promoted due to the addition of biosurfactant 2-hexyl-3-hydroxy-decanoic acid.

In this experiment, the mixed cultured strain of Examples 2, 6 and 7 was added to tryptic soy broth (TSB) and then cultured for 13 hours. In the culture process, the microbial strain was added into a 100-ml flask at an initial concentration of 4.9×10⁶ cfu/ml to a work volume of 10 ml, and the inoculation level of the strain was 1% (w/v), i.e., 0.1 ml.

As shown in Table 5 below, each of the media used in this experiment contained a suitable mixture of glucose, yeast extract, malt extract, Na₂HPO₄, KH₂PO₄, K₂HPO₄, MgSO₄, CaCl₂, FeSO₄, CoCl₂, ZnSO₄, CuSO₄ and MnSO₄, and the biosurfactant 2-hexyl-3-hydroxy-decanoic acid was used in Examples 16 and 17.

In Comparative Examples 7-10 and Examples 16 and 17, the microbial strain was cultured in media (10 g/L) at 30° C. for 24 hours, and then measured for colony-forming units (cfu) per ml to determine the degree of proliferation of microorganisms.

Specifically, a composition used in Comparative Examples 7-10 consisted of glucose, yeast extract, malt extract, Na₂HPO₄, KH₂PO₄, K₂HPO₄, MgSO₄, CaCl₂, FeSO₄, CoCl₂, ZnSO₄, CuSO₄ and MnSO₄, and a composition used in Examples 16 and 17 consisted of glucose, yeast extract, malt extract, Na₂HPO₄, KH₂PO₄, K₂HPO₄, MgSO₄, CaCl₂, FeSO₄, CoCl₂, ZnSO₄, CuSO₄ and MnSO₄, to which the biosurfactant 2-hexyl-3-hydroxy-decanoic acid was added.

Hereinafter, the present invention will be described in further detail with reference to preferred embodiments.

TABLE 5

| | | | | Comp. | | |
|---|---|---|---|---|---|---|
| | Comp. | Comp. | Comp. | Example | Example | Example |
| Components of composition | Example 7 | Example 8 | Example 9 | 10 | 16 | 17 |
| Glucose | 52.6 | 42.5 | 54.0 | 42.5 | 54.0 | 42.5 |
| Yeast extract | 15.8 | 14.9 | 29.7 | 29.8 | 29.7 | 29.8 |
| Malt extract | 15.8 | 29.8 | | 14.9 | | 14.9 |
| Na₂HPO₄ | 9.5 | 7.7 | | 7.7 | | 7.7 |
| KH₂PO₄ | 4.7 | 3.8 | 4.9 | 3.8 | 4.9 | 3.8 |
| K₂HPO₄ | | | 9.7 | | 9.7 | |
| MgSO₄ | 1.6 | 1.3 | 1.6 | 1.3 | 1.6 | 1.3 |
| CaCl₂ | 0.1 | 0.1 | 0.1 | 0.1 | 0.1 | 0.1 |
| FeSO₄ | 0.003 | 0.002 | 0.003 | 0.002 | 0.003 | 0.002 |
| CoCl₂ | 0.003 | 0.002 | 0.003 | 0.002 | 0.003 | 0.002 |
| ZnSO₄ | 0.003 | 0.002 | 0.003 | 0.002 | 0.003 | 0.002 |
| CuSO₄ | 0.003 | 0.002 | 0.003 | 0.002 | 0.003 | 0.002 |
| MnSO₄ | 0.003 | 0.002 | 0.003 | 0.002 | 0.003 | 0.002 |
| 2-hexyl-3-hydroxy-decanoic acid | | | | | 0.1 | 0.1 |
| Amount used (g/L) | 10 | 10 | 10 | 10 | 10 | 10 |
| Initial inoculation level of | 4.9 × 10⁶ | 4.9 × 10⁶ | 4.9 × 10⁶ | 4.9 × 10⁶ | 4.9 × 10⁶ | 4.9 × 10⁶ |
| microorganisms (cfu/ml) | | | | | | |
| Total number of microorganisms | 1.1 × 10⁸ | 2.8 × 10⁸ | 1.2 × 10⁹ | 2.2 × 10⁹ | 1.7 × 10¹¹ | 3.1 × 10¹¹ |
| after culture (cfu/ml) | | | | | | |

As can be seen Table 5 above, Comparative Examples 7-10, to which 2-hexyl-3-hydroxy-decanoic acid was not added, showed a total number of microorganisms of 1.1×10⁸ to 2.2×10⁹ cfu/ml. On the other hand, the total microorganism numbers in Examples 16 and 17, to which 2-hexyl-3-hydroxy-decanoic acid was added, were 1.7×10¹¹ cfu/ml and 3.1×10¹¹ cfu/ml. This suggests that the addition of 2-hexyl-3-hydroxy-decanoic acid leads to the promotion of growth of the microorganisms.

### EXAMPLE 18 THROUGH 39 AND COMPARATIVE EXAMPLES 11 AND 12

### Preparation of Synthetic Biosurfactants

Examples below illustrate the synthesis of biosurfactants from an alkyl ketene dimer having 8, 12 or 16-18 carbon atoms, but the scope of the present invention is not limited thereto.

### EXAMPLE 18

Step 1: 100 g (0.39 mol) of a C₈ alkyl ketene dimer was added to 800 ml of EA:EtOH=3:1 and stirred well. Then, 0.1 g (0.1 wt %) of 10% Pd/C was added thereto, and the mixture was sealed well, and stirred well at a pressure of 2 atm in a H₂ atmosphere for 3-4 hours. After completion of the reaction, the reaction product was filtered through celite, and the solvent was evaporated under reduced pressure, yielding 96 g (95% yield) of 2-hexyl-3-hydroxy-decanoic β-lactone as a light yellow liquid.

R_{f} (EA:Hex=1:20): 0.58

¹H NMR (CDCl₃): δ 0.87 (t, 6H, CH₃), 1.12-1.91 (br, 22H, CH₂), 3.60 (m, 1H, CH₂CHCO), 4.51 (m, 1H, CHCH—O).

Step 2: 12 g (0.3 mol, 1.5 eq) of NaOH was dissolved in 600 ml of EtOH:H₂O=3:1, and 50 g (0.20 mol) of 2-hexyl-3-hydroxy-decanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. The residue was separated by column chromatography (MC:EtOH=45:1), and the solvent was evaporated under reduced pressure, yielding 51 g (95% yield) of 2-hexyl-3-hydroxy-decanoic acid as a light yellow syrup.

R_{f} (MC:EtOH=45:1): 0.48

¹H NMR (CDCl₃): δ 0.87 (t, 6H, CH₃), 1.12-1.91 (br, 22H, CH₂), 2.45 (m, 1H, CHCHCO), 3.76 (m, 1H, CH₂CH(OH)CH).

### EXAMPLE 19

Step 1: 100 g (0.39 mol) of a C₈ alkyl ketene dimer was added to 800 ml of EA:EtOH=3:1 and stirred well. Then, 0.1 g (0.1 wt %) of 10% Pd/C was added thereto, and the mixture was sealed well, and stirred well at a pressure of 15 atm in a H₂ atmosphere for 3-4 hours. After completion of the reaction, the reaction product was filtered through celite, and the solvent was evaporated under reduced pressure, yielding 98 g (97% yield) of 2-hexyl-3-hydroxy-decanoic β-lactone as a light yellow liquid.

R_{f} (EA:Hex=1:20): 0.58

¹H NMR (CDCl₃): δ 0.87 (t, 6H, CH₃), 1.12-1.91 (br, 22H, CH₂), 3.60 (m, 1H, CH₂CHCO), 4.51 (m, 1H, CHCH—O).

Step 2: 12 g (0.3 mol, 1.5 eq) of NaOH was dissolved in 600 ml of EtOH:H₂O=3:1, and 50 g (0.20 mol) of 2-hexyl-3-hydroxy-decanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. The residue was separated by column chromatography (MC:EtOH=45:1), and the solvent was evaporated under reduced pressure, yielding 51 g (95% yield) of 2-hexyl-3-hydroxy-decanoic acid as a light yellow syrup.

R_{f} (MC:EtOH=45:1): 0.48

¹H NMR (CDCl₃): δ 0.87 (t, 6H, CH₃), 1.12-1.91 (br, 22H, CH₂), 2.45 (m, 1H, CHCHCO), 3.76 (m, 1H, CH₂CH(OH)CH).

### EXAMPLE 20

Step 1: 100 g (0.39 mol) of a C₈ alkyl ketene dimer was added to 800 ml of EtOH and stirred well. Then, 0.1 g (0.1 wt %) of 10% Pd/C was added thereto, and the mixture was sealed well, and stirred well at a pressure of 30 atm in a H₂ atmosphere for 3-4 hours. After completion of the reaction, the reaction product was filtered through celite, and the solvent was evaporated under reduced pressure. The residue was separated by column chromatography (EA:Hex=1:20), and the solvent was evaporated under reduced pressure, yielding 91 g (90% yield) of 2-hexyl-3-hydroxy-decanoic β-lactone as a light yellow liquid.

R_{f} (EA:Hex=1:20): 0.58

¹H NMR (CDCl₃): δ 0.87 (t, 6H, CH₃), 1.12-1.91 (br, 22H, CH₂), 3.60 (m, 1H, CH₂CHCO), 4.51 (m, 1H, CHCH—O).

Step 2: 12 g (0.3 mol, 1.5 eq) of NaOH was dissolved in 600 ml of EtOH:H₂O=3:1, and 50 g (0.20 mol) of 2-hexyl-3-hydroxy-decanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. The residue was separated by column chromatography (MC:EtOH=45:1), and the solvent was evaporated under reduced pressure, yielding 51 g (95% yield) of 2-hexyl-3-hydroxy-decanoic acid as a light yellow syrup.

R_{f} (MC:EtOH=45:1): 0.48

¹H NMR (CDCl₃): δ 0.87 (t, 6H, CH₃), 1.12-1.91 (br, 22H, CH₂), 2.45 (m, 1H, CHCHCO), 3.76 (m, 1H, CH₂CH(OH)CH).

### EXAMPLE 21

Step 1: 100 g (0.39 mol) of a C₈ alkyl ketene dimer was added to 800 ml of EA:EtOH=3:1 and stirred well. Then, 0.2 g (0.2 wt %) of 5% Pd/C was added thereto, and the mixture was sealed well, and stirred well at a pressure of 2 atm in a H₂ atmosphere for 3-4 hours. After completion of the reaction, the reaction product was filtered through celite, and the solvent was evaporated under reduced pressure, yielding 96 g (95% yield) of 2-hexyl-3-hydroxy-decanoic β-lactone as a light yellow liquid.

R_{f} (EA:Hex=1:20): 0.58

¹H NMR (CDCl₃): δ 0.87 (t, 6H, CH₃), 1.12-1.91 (br, 22H, CH₂), 3.60 (m, 1H, CH₂CHCO), 4.51 (m, 1H, CHCH—O).

Step 2: 12 g (0.3 mol, 1.5 eq) of NaOH was dissolved in 600 ml of EtOH:H₂O=3:1, and 50 g (0.20 mol) of 2-hexyl-3-hydroxy-decanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. The residue was separated by column chromatography (MC:EtOH=45:1), and the solvent was evaporated under reduced pressure, yielding 51 g (95% yield) of 2-hexyl-3-hydroxy-decanoic acid as a light yellow syrup.

R_{f} (MC:EtOH=45:1): 0.48

¹H NMR (CDCl₃): δ 0.87 (t, 6H, CH₃), 1.12-1.91 (br, 22H, CH₂), 2.45 (m, 1H, CHCHCO), 3.76 (m, 1H, CH₂CH(OH)CH).

### EXAMPLE 22

Step 1: 100 g (0.39 mol) of a C₈ alkyl ketene dimer was added to 900 ml of EA:EtOH=2:1 and stirred well. Then, 0.2 g (0.2 wt %) of 5% Pd/C was added thereto, and the mixture was sealed well, and stirred well at a pressure of 15 atm in a H₂ atmosphere for 3-4 hours. After completion of the reaction, the reaction product was filtered through celite, and the solvent was evaporated under reduced pressure, yielding 96 g (95% yield) of 2-hexyl-3-hydroxy-decanoic β-lactone as a light yellow liquid.

R_{f} (EA:Hex=1:20): 0.58

¹H NMR (CDCl₃): δ 0.87 (t, 6H, CH₃), 1.12-1.91 (br, 22H, CH₂), 3.60 (m, 1H, CH₂CHCO), 4.51 (m, 1H, CHCH—O).

Step 2: 12 g (0.3 mol, 1.5 eq) of NaOH was dissolved in 600 ml of EtOH:H₂O=3:1, and 50 g (0.20 mol) of 2-hexyl-3-hydroxy-decanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. The residue was separated by column chromatography (MC:EtOH=45:1), and the solvent was evaporated under reduced pressure, yielding 51 g (95% yield) of 2-hexyl-3-hydroxy-decanoic acid as a light yellow syrup.

R_{f} (MC:EtOH=45:1): 0.48

¹H NMR (CDCl₃): δ 0.87 (t, 6H, CH₃), 1.12-1.91 (br, 22H, CH₂), 2.45 (m, 1H, CHCHCO), 3.76 (m, 1H, CH₂CH(OH)CH).

### EXAMPLE 23

Step 1: 100 g (0.39 mol) of a C₈ alkyl ketene dimer was added to 800 ml of EtOH and stirred well. Then, 0.2 g (0.2 wt %) of 5% Pd/C was added thereto, and the mixture was sealed well, and stirred well at a pressure of 40 atm in a H₂ atmosphere for 4-5 hours. After completion of the reaction, the reaction product was filtered through celite, and the solvent was evaporated under reduced pressure. The residue was separated by column chromatography (EA:Hex=1:20), and the solvent was evaporated under reduced pressure, yielding 90 g (89% yield) of 2-hexyl-3-hydroxy-decanoic ⊖-lactone as a light yellow liquid.

R_{f} (EA:Hex=1:20): 0.58

¹H NMR (CDCl₃): δ 0.87 (t, 6H, CH₃), 1.12-1.91 (br, 22H, CH₂), 3.60 (m, 1H, CH₂CHCO), 4.51 (m, 1H, CHCH—O).

Step 2: 12 g (0.3 mol, 1.5 eq) of NaOH was dissolved in 600 ml of EtOH:H₂O=3:1, and 50 g (0.20 mol) of 2-hexyl-3-hydroxy-decanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. The residue was separated by column chromatography (MC:EtOH=45:1), and the solvent was evaporated under reduced pressure, yielding 51 g (95% yield) of 2-hexyl-3-hydroxy-decanoic acid as a light yellow syrup.

R_{f} (MC:EtOH=45:1): 0.48

¹H NMR (CDCl₃): δ 0.87 (t, 6H, CH₃), 1.12-1.91 (br, 22H, CH₂), 2.45 (m, 1H, CHCHCO), 3.76 (m, 1H, CH₂CH(OH)CH).

### EXAMPLE 24

Step 1: 100 g (0.39 mol) of a C₈ alkyl ketene dimer was added to 800 ml of EA:EtOH=3:1 and stirred well. Then, 2 g (2 wt %) of 0.5% Pd/Al₂O₃ was added thereto, and the mixture was sealed well, and stirred well at a pressure of 2 atm in a H₂ atmosphere for 4-5 hours. After completion of the reaction, the reaction product was filtered through 0.5% Pd/Al₂O₃, and the solvent was evaporated under reduced pressure, yielding 96 g (95% yield) of 2-hexyl-3-hydroxy-decanoic β-lactone as a light yellow liquid.

R_{f} (EA:Hex=1:20): 0.58

¹H NMR (CDCl₃): δ 0.87 (t, 6H, CH₃), 1.12-1.91 (br, 22H, CH₂), 3.60 (m, 1H, CH₂CHCO), 4.51 (m, 1H, CHCH—O).

Step 2: 12 g (0.3 mol, 1.5 eq) of NaOH was dissolved in 600 ml of EtOH:H₂O=3:1, and 50 g (0.20 mol) of 2-hexyl-3-hydroxy-decanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. The residue was separated by column chromatography (MC:EtOH=45:1), and the solvent was evaporated under reduced pressure, yielding 51 g (95% yield) of 2-hexyl-3-hydroxy-decanoic acid as a light yellow syrup.

R_{f} (MC:EtOH=45:1): 0.48

¹H NMR (CDCl₃): δ 0.87 (t, 6H, CH₃), 1.12-1.91 (br, 22H, CH₂), 2.45 (m, 1H, CHCHCO), 3.76 (m, 1H, CH₂CH(OH)CH).

### EXAMPLE 25

Step b 1: 100 g (0.39 mol) of a C₈ alkyl ketene dimer was added to 800 ml of EA:EtOH=1:1 and stirred well. Then, 2 g (2 wt %) of onetime recycled 0.5% Pd/Al₂O₃ was added thereto, and the mixture was sealed well, and stirred well at a pressure of 15 atm in a H₂ atmosphere for 4-5 hours. After completion of the reaction, the reaction product was filtered through 0.5% Pd/Al₂O₃, and the solvent was evaporated under reduced pressure, yielding 95 g (94% yield) of 2-hexyl-3-hydroxy-decanoic β-lactone as a light yellow liquid.

R_{f} (EA:Hex=1:20): 0.58

¹H NMR (CDCl₃): δ 0.87 (t, 6H, CH₃), 1.12-1.91 (br, 22H, CH₂), 3.60 (m, 1H, CH₂CHCO), 4.51 (m, 1H, CHCH—O).

Step 2: 12 g (0.3 mol, 1.5 eq) of NaOH was dissolved in 600 ml of EtOH:H₂O=3:1, and 50 g (0.20 mol) of 2-hexyl-3-hydroxy-decanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. The residue was separated by column chromatography (MC:EtOH=45:1), and the solvent was evaporated under reduced pressure, yielding 51 g (95% yield) of 2-hexyl-3-hydroxy-decanoic acid as a light yellow syrup.

R_{f} (MC:EtOH=45:1): 0.48

¹H NMR (CDCl₃): δ 0.87 (t, 6H, CH₃), 1.12-1.91 (br, 22H, CH₂), 2.45 (m, 1H, CHCHCO), 3.76 (m, 1H, CH₂CH(OH)CH).

### EXAMPLE 26

Step 1: 100 g (0.39 mol) of a C₈ alkyl ketene dimer was added to 800 ml of EtOH and stirred well. Then, 2 g (2 wt %) of twice recycled 0.5% Pd/Al₂O₃ was added thereto, and the mixture was sealed well, and stirred well at a pressure of 50 atm in a H₂ atmosphere for 4-5 hours. After completion of the reaction, the reaction product was filtered through 0.5% Pd/Al₂O₃, and the solvent was evaporated under reduced pressure, The residue was separated by column chromatography (EA:Hex=1:20), and the solvent was evaporated under reduced pressure, yielding 89 g (88% yield) of 2-hexyl-3-hydroxy-decanoic β-lactone as a light yellow liquid.

R_{f} (EA:Hex=1:20): 0.58

¹H NMR (CDCl₃): δ 0.87 (t, 6H, CH₃), 1.12-1.91 (br, 22H, CH₂), 3.60 (m, 1H, CH₂CHCO), 4.51 (m, 1H, CHCH—O).

Step b 2: 12 g (0.3 mol, 1.5 eq) of NaOH was dissolved in 600 ml of EtOH:H₂O=3:1, and 50 g (0.20 mol) of 2-hexyl-3-hydroxy-decanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. The residue was separated by column chromatography (MC:EtOH=45:1), and the solvent was evaporated under reduced pressure, yielding 51 g (95% yield) of 2-hexyl-3-hydroxy-decanoic acid as a light yellow syrup.

R_{f} (MC:EtOH=45:1): 0.48

¹H NMR (CDCl₃): δ 0.87 (t, 6H, CH₃), 1.12-1.91 (br, 22H, CH₂), 2.45 (m, 1H, CHCHCO), 3.76 (m, 1H, CH₂CH(OH)CH).

### EXAMPLE 27

Step 1: 100 g (0.27 mol) of a C₁₂ alkyl ketene dimer was added to 900 ml of EA:EtOH=2:1 and stirred well. Then, 0.1 g (0.1 wt %) of 10% Pd/C was added thereto, and the mixture was sealed well, and stirred well at a pressure of 2 atm in a H₂ atmosphere for 3-4 hours. After completion of the reaction, the reaction product was filtered through celite, and the solvent was evaporated under reduced pressure, yielding 94 g (94% yield) of 2-decyl-3-hydroxy-tetradecanoic β-lactone as a white solid.

R_{f} (EA:Hex=1:20): 0.58 mp: 35.97° c

¹H NMR (CDCl₃): δ 0.88 (t, 6H, CH₃), 1.12-1.91 (br, 38H, CH₂), 3.60 (m, 1H, CH₂CHCO), 4.56 (m, 1H, CHCH—O).

Step 2: 3.2 g (0.075 mol, 1.5 eq) of NaOH was dissolved in 600 ml of EtOH:H₂O=3:1, and 20 g (0.05 mol) of 2-decyl-3-hydroxy-tetradecanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. The residue was separated by column chromatography (MC:EtOH=45:1), and the solvent was evaporated under reduced pressure, yielding 19.9 g (95% yield) of 2-decyl-3-hydroxy-tetradecanoic acid as a white solid.

R_{f} (MC:EtOH=45:1): 0.49

¹H NMR (CDCl₃): δ 0.88 (t, 6H, CH₃), 1.12-1.91 (br, 38H, CH₂), 2.48 (m, 1H, CHCHCO), 3.85 (m, 1H, CH₂CH(OH)CH).

### EXAMPLE 28

Step 1: 100 g (0.27 mol) of a C₁₂ alkyl ketene dimer was added to 900 ml of EA:EtOH=2:1 and stirred well. Then, 0.1 g (0.1 wt %) of 10% Pd/C was added thereto, and the mixture was sealed well, and stirred well at a pressure of 15 atm in a H₂ atmosphere for 3-4 hours. After completion of the reaction, the reaction product was filtered through celite, and the solvent was evaporated under reduced pressure, yielding 96 g (96% yield) of 2-decyl-3-hydroxy-tetradecanoic β-lactone as a white solid.

R_{f} (EA:Hex=1:20): 0.58 mp: 35.97° c

¹H NMR (CDCl₃): δ 0.88 (t, 6H, CH₃), 1.12-1.91 (br, 38H, CH₂), 3.60 (m, 1H, CH₂CHCO), 4.56 (m, 1H, CHCH—O).

Step 2: 3.2 g (0.075 mol, 1.5 eq) of NaOH was dissolved in 600 ml of EtOH:H₂O=3:1, and 20 g (0.05 mol) of 2-decyl-3-hydroxy-tetradecanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. The residue was separated by column chromatography (MC:EtOH=45:1), and the solvent was evaporated under reduced pressure, yielding 19.9 g (95% yield) of 2-decyl-3-hydroxy-tetradecanoic acid as a white solid.

R_{f} (MC:EtOH=45:1): 0.49

¹H NMR (CDCl₃): δ 0.88 (t, 6H, CH₃), 1.12-1.91 (br, 38H, CH₂), 2.48 (m, 1H, CHCHCO), 3.85 (m, 1H, CH₂CH(OH)CH).

### EXAMPLE 29

Step 1: 100 g (0.27 mol) of a C₁₂ alkyl ketene dimer was added to 800 ml of EA:EtOH=1:1 and stirred well. Then, 0.2 g (0.2 wt %) of 5% Pd/C was added thereto, and the mixture was sealed well, and stirred well at a pressure of 15 atm in a H₂ atmosphere for 4-5 hours. After completion of the reaction, the reaction product was filtered through celite, and the solvent was evaporated under reduced pressure, yielding 93 g (93% yield) of 2-decyl-3-hydroxy-tetradecanoic β-lactone as a white solid.

R_{f} (EA:Hex=1:20): 0.58 mp: 35.97° c

¹H NMR (CDCl₃): δ 0.88 (t, 6H, CH₃), 1.12-1.91 (br, 38H, CH₂), 3.60 (m, 1H, CH₂CHCO), 4.56 (m, 1H, CHCH—O).

Step 2: 3.2 g (0.075 mol, 1.5 eq) of NaOH was dissolved in 600 ml of EtOH:H₂O=3:1, and 20 g (0.05 mol) of 2-decyl-3-hydroxy-tetradecanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. The residue was separated by column chromatography (MC:EtOH=45:1), and the solvent was evaporated under reduced pressure, yielding 19.9 g (95% yield) of 2-decyl-3-hydroxy-tetradecanoic acid as a white solid.

R_{f} (MC:EtOH=45:1): 0.49

¹H NMR (CDCl₃): δ 0.88 (t, 6H, CH₃), 1.12-1.91 (br, 38H, CH₂), 2.48 (m, 1H, CHCHCO), 3.85 (m, 1H, CH₂CH(OH)CH).

### EXAMPLE 30

Step 1: 100 g (0.27 mol) of a C₁₂ alkyl ketene dimer was added to 900 ml of EA:EtOH=1:2 and stirred well. Then, 2 g (2 wt %) of five times recycled 0.5% Pd/Al₂O₃ was added thereto, and the mixture was sealed well, and stirred well at a pressure of 15 atm in a H₂ atmosphere for 4-5 hours. After completion of the reaction, the reaction product was filtered through 0.5% Pd/Al₂O₃, and the solvent was evaporated under reduced pressure. The residue was separated by column chromatography (EA:Hex=1:20), and the solvent was evaporated under reduced pressure, yielding 89 g (89% yield) of 2-decyl-3-hydroxy-tetradecanoic β-lactone as a white solid.

R_{f} (EA:Hex=1:20): 0.58 mp: 35.97° c

¹H NMR (CDCl₃): δ 0.88 (t, 6H, CH₃), 1.12-1.91 (br, 38H, CH₂), 3.60 (m, 1H, CH₂CHCO), 4.56 (m, 1H, CHCH—O).

Step 2: 3.2 g (0.075 mol, 1.5 eq) of NaOH was dissolved in 600 ml of EtOH:H₂O=3:1, and 20 g (0.05 mol) of 2-decyl-3-hydroxy-tetradecanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. The residue was separated by column chromatography (MC:EtOH=45:1), and the solvent was evaporated under reduced pressure, yielding 19.9 g (95% yield) of 2-decyl-3-hydroxy-tetradecanoic acid as a white solid.

R_{f} (MC:EtOH=45:1): 0.49

¹H NMR (CDCl₃): δ 0.88 (t, 6H, CH₃), 1.12-1.91 (br, 38H, CH₂), 2.48 (m, 1H, CHCHCO), 3.85 (m, 1H, CH₂CH(OH)CH).

### EXAMPLE 31

Step 1: 100 g (0.27 mol) of a C₁₂ alkyl ketene dimer was added to 800 ml of EtOH and stirred well. Then, 0.2 g (0.2 wt %) of 5% Pd/C was added thereto, and the mixture was sealed well, and stirred well at a pressure of 40 atm in a H₂ atmosphere for 4-5 hours. After completion of the reaction, the reaction product was filtered through celite, and the solvent was evaporated under reduced pressure, yielding 90 g (90% yield) of 2-decyl-3-hydroxy-tetradecanoic β-lactone as a white solid.

R_{f} (EA:Hex=1:20): 0.58 mp: 35.97° c

¹H NMR (CDCl₃): δ 0.88 (t, 6H, CH₃), 1.12-1.91 (br, 38H, CH₂), 3.60 (m, 1H, CH₂CHCO), 4.56 (m, 1H, CHCH—O).

Step 2: 3.2 g (0.075 mol, 1.5 eq) of NaOH was dissolved in 600 ml of EtOH:H₂O=3:1, and 20 g (0.05 mol) of 2-decyl-3-hydroxy-tetradecanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. The residue was separated by column chromatography (MC:EtOH=45:1), and the solvent was evaporated under reduced pressure, yielding 19.9 g (95% yield) of 2-decyl-3-hydroxy-tetradecanoic acid as a white solid.

R_{f} (MC:EtOH=45:1): 0.49

¹H NMR (CDCl₃): δ 0.88 (t, 6H, CH₃), 1.12-1.91 (br, 38H, CH₂), 2.48 (m, 1H, CHCHCO), 3.85 (m, 1H, CH₂CH(OH)CH).

### EXAMPLE 32

Step 1: 100 g (0.19 mol) of a C₁₆₋₁₈ alkyl ketene dimer was added to 800 ml of EA:EtOH=1:1 to be heated and completely melted and stirred well. Then, 0.1 g (0.1 wt %) of 10% Pd/C was added thereto, and the mixture was sealed well, and stirred well at a pressure of 2 atm in a H₂ atmosphere for 3-4 hours. After completion of the reaction, the reaction product was filtered through celite, and the solvent was evaporated under reduced pressure. It was recrystallized from EtOH, yielding 92 g (92% yield) of 2-hexadecyl/tetradecyl-3-hydroxy-eicosanoic/octadecanoic β-lactone as a white solid.

R_{f} (EA:Hex=1:20): 0.58 mp: 60.89° c

¹H NMR (CDCl₃): δ 0.88 (t, 6H, CH₃), 1.12-1.91 (br, 62H, CH₂), 3.59 (m, 1H, CH₂CHCO), 4.56 (m, 1H, CHCH—O).

Step 2: 5.6 g (0.14 mol, 1.5 eq) of NaOH was dissolved in 600 ml of EtOH:H₂O=3:1, and 50 g (0.09 mol) of 2-hexadecyl/tetradecyl-3-hydroxy-eicosanoic/octadecanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. It was recrystallized from EtOH, yielding 49 g (95% yield) of 2-hexadecyl/tetradecyl-3-hydroxy-eicosanoic/octadecanoic acid as a white solid.

R_{f} (MC:EtOH=45:1): 0.49

¹H NMR (CDCl₃): δ 0.86 (t, 6H, CH₃), 1.12-1.91 (br, 62H, CH₂), 2.46 (m, 1H, CHCHCO), 3.85 (m, 1H, CH₂CH(OH)CH).

### EXAMPLE 33

Step 1: 100 g (0.19 mol) of a C₁₆₋₁₈ alkyl ketene dimer was added to 800 ml of EtOH to be heated and completely melted and stirred well. Then, 0.1 g (0.1 wt %) of 10% Pd/C was added thereto, and the mixture was sealed well, and stirred well at a pressure of 2 atm in a H₂ atmosphere for 3-4 hours. After completion of the reaction, the reaction product was filtered through celite, and the solvent was evaporated under reduced pressure. It was recrystallized from EtOH, yielding 94 g (94% yield) of 2-hexadecyl/tetradecyl-3-hydroxy-eicosanoic/octadecanoic β-lactone as a white solid.

R_{f} (EA:Hex=1:20): 0.58 mp: 60.89° c

¹H NMR (CDCl₃): δ 0.88 (t, 6H, CH₃), 1.12-1.91 (br, 62H, CH₂), 3.59 (m, 1H, CH₂CHCO), 4.56 (m, 1H, CHCH—O).

Step 2: 5.6 g (0.14 mol, 1.5 eq) of NaOH was dissolved in 600 ml of EtOH:H₂O=3:1, and 50 g (0.09 mol) of 2-hexadecyl/tetradecyl-3-hydroxy-eicosanoic/octadecanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. It was recrystallized from EtOH, yielding 49 g (95% yield) of 2-hexadecyl/tetradecyl-3-hydroxy-eicosanoic/octadecanoic acid as a white solid.

R_{f} (MC:EtOH=45:1): 0.49

¹H NMR (CDCl₃): δ 0.86 (t, 6H, CH₃), 1.12-1.91 (br, 62H, CH₂), 2.46 (m, 1H, CHCHCO), 3.85 (m, 1H, CH₂CH(OH)CH).

### EXAMPLE 34

Step 1: 100 g (0.19 mol) of a C₁₆₋₁₈ alkyl ketene dimer was added to 800 ml of EtOH to be heated and completely melted and stirred well. Then, 0.2 g (0.2 wt %) of 5% Pd/C was added thereto, and the mixture was sealed well, and stirred well at a pressure of 30 atm in a H₂ atmosphere for 4-5 hours. After completion of the reaction, the reaction product was filtered through celite, and the solvent was evaporated under reduced pressure. It was recrystallized from EtOH, yielding 94 g (94% yield) of 2-hexadecyl/tetradecyl-3-hydroxy-eicosanoic/octadecanoic β-lactone as a white solid.

R_{f} (EA:Hex=1:20): 0.58 mp: 60.89° c

¹H NMR (CDCl₃): δ 0.88 (t, 6H, CH₃), 1.12-1.91 (br, 62H, CH₂), 3.59 (m, 1H, CH₂CHCO), 4.56 (m, 1H, CHCH—O).

Step 2: 5.6 g (0.14 mol, 1.5 eq) of NaOH was dissolved in 600 ml of EtOH:H₂O=3:1, and 50 g (0.09 mol) of 2-hexadecyl/tetradecyl-3-hydroxy-eicosanoic/octadecanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. It was recrystallized from EtOH, yielding 49 g (95% yield) of 2-hexadecyl/tetradecyl-3-hydroxy-eicosanoic/octadecanoic acid as a white solid.

R_{f} (MC:EtOH=45:1): 0.49

¹H NMR (CDCl₃): δ 0.86 (t, 6H, CH₃), 1.12-1.91 (br, 62H, CH₂), 2.46 (m, 1H, CHCHCO), 3.85 (m, 1H, CH₂CH(OH)CH).

### EXAMPLE 35

Step 1: 100 g (0.19 mol) of a C₁₆₋₁₈ alkyl ketene dimer was added to 800 ml of EtOH to be heated and completely melted and stirred well. Then, 2 g (2 wt %) of ten times recycled 0.5% Pd/Al₂O₃ was added thereto, and the mixture was sealed well, and stirred well at a pressure of 50 atm in a H₂ atmosphere for 4-5 hours. After completion of the reaction, the reaction product was filtered through 0.5% Pd/Al₂O₃, and the solvent was evaporated under reduced pressure. It was recrystallized from EtOH, yielding 91 g (91% yield) of 2-hexadecyl/tetradecyl-3-hydroxy-eicosanoic/octadecanoic β-lactone as a white solid.

R_{f} (EA:Hex=1:20): 0.58 mp: 60.89° c

¹H NMR (CDCl₃): δ 0.88 (t, 6H, CH₃), 1.12-1.91 (br, 62H, CH₂), 3.59 (m, 1H, CH₂CHCO), 4.56 (m, 1H, CHCH—O).

Step 2: 5.6 g (0.14 mol, 1.5 eq) of NaOH was dissolved in 600 ml of EtOH:H₂O=3:1, and 50 g (0.09 mol) of 2-hexadecyl/tetradecyl-3-hydroxy-eicosanoic/octadecanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. It was recrystallized from EtOH, yielding 49 g (95% yield) of 2-hexadecyl/tetradecyl-3-hydroxy-eicosanoic/octadecanoic acid as a white solid.

R_{f} (MC:EtOH=45:1): 0.49

¹H NMR (CDCl₃): δ 0.86 (t, 6H, CH₃), 1.12-1.91 (br, 62H, CH₂), 2.46 (m, 1H, CHCHCO), 3.85 (m, 1H, CH₂CH(OH)CH).

### EXAMPLE 36

Step 1: 100 g (0.19 mol) of a C₁₆₋₁₈ alkyl ketene dimer was added to 800 ml of EtOH to be heated and completely melted and stirred well. Then, 2 g (2 wt %) of a new 0.5% Pd/Al₂O₃ was added thereto, and the mixture was sealed well, and stirred well at a pressure of 50 atm in a H₂ atmosphere for 4-5 hours. After completion of the reaction, the reaction product was filtered through 0.5% Pd/Al₂O₃, and the solvent was evaporated under reduced pressure. It was recrystallized from EtOH, yielding 95 g (95% yield) of 2-hexadecyl/tetradecyl-3-hydroxy-eicosanoic/octadecanoic β-lactone as a white solid.

R_{f} (EA:Hex=1:20): 0.58 mp: 60.89° c

¹H NMR (CDCl₃): δ 0.88 (t, 6H, CH₃), 1.12-1.91 (br, 62H, CH₂), 3.59 (m, 1H, CH₂CHCO), 4.56 (m, 1H, CHCH—O).

Step 2: 5.6 g (0.14 mol, 1.5 eq) of NaOH was dissolved in 600 ml of EtOH:H₂O=3:1, and 50 g (0.09 mol) of 2-hexadecyl/tetradecyl-3-hydroxy-eicosanoic/octadecanoic β-lactone was added thereto and stirred well for 3-4 hours. Then, the stirred solution was acidified with 6N HCl. The acidic solution was extracted with methylene chloride (MC), and the MC layer was dried over Na₂SO₄ and filtered. The solvent was evaporated under reduced pressure. It was recrystallized from EtOH, yielding 49 g (95% yield) of 2-hexadecyl/tetradecyl-3-hydroxy-eicosanoic/octadecanoic acid as a white solid.

R_{f} (MC:EtOH=45:1): 0.49

¹H NMR (CDCl₃): δ 0.86 (t, 6H, CH₃), 1.12-1.91 (br, 62H, CH₂), 2.46 (m, 1H, CHCHCO), 3.85 (m, 1H, CH₂CH(OH)CH).

### EXAMPLE 37

20 g (0.078 mol) of 2-hexyl-3-hydroxy-decanoic β-lactone and 17 g (0.94 mol, 1.2 eq) of glucose were added to 200 ml of DMF (N,N-dimethylformamide). A catalytic amount of sulfuric acid was added thereto, and the solution was heated under reflux for 10-24 hours. The reaction solution was cooled to room temperature, 100 ml of water was added thereto, and the aqueous solution was neutralized with 1N NaOH. The neutral solution was extracted with methylene chloride (MC), the MC layer was dried with Na₂SO₄ and filtered, and the solvent was evaporated under reduced pressure. The residue was separated by column chromatography (MC:EtOH=20:1), and the solvent was evaporated under reduced pressure, yielding 21.5 g (63% yield) of 2-hexyl-3-hydroxy-decanoic acid glucose ester as a white solid.

R_{f} (MC:EtOH=10:1): 0.41

¹H NMR (CDCl₃): δ 0.88 (t, 6H, CH₃), 1.12-1.91 (br, 22H, CH₂), 2.45 (m, 1H, CHCHCO), 3.40 (m, 1H, CH₂CHOCH(OH)CH(OH)), 3.48-3.52 (m, 2H, (OH)CHCH(OH)CH(OH)), 3.76 (m, 1H, CH₂CH(OH)CH), 4.21 (d, 2H, OCH₂CH), 4.27 (m, 1H, CH₂CHOCH(OH)), 5.41 (d, 1H, OCH(OH) CH(OH)).

### EXAMPLE 38

20 g (0.078 mol) of 2-hexyl-3-hydroxy-decanoic β-lactone and 17 g (0.94 mol, 1.2 eq) of mannose were added to 200 ml of DMF (N,N-dimethylformamide). A catalytic amount of sulfuric acid was added thereto, and the solution was heated under reflux for 10-24 hours. The reaction solution was cooled to room temperature, 100 ml of water was added thereto, and the aqueous solution was neutralized with 1N NaOH. The neutral solution was extracted with methylene chloride (MC), the MC layer was dried with Na₂SO₄ and filtered, and the solvent was evaporated under reduced pressure. The residue was separated by column chromatography (MC:EtOH=20:1), and the solvent was evaporated under reduced pressure, yielding 20.5 g (60% yield) of 2-hexyl-3-hydroxy-decanoic acid mannose ester as a white solid.

R_{f} (MC:EtOH=10:1): 0.41

¹H NMR (CDCl₃): δ 0.88 (t, 6H, CH₃), 1.12-1.91 (br, 22H, CH₂), 2.45 (m, 1H, CHCHCO), 3.40 (m, 1H, CH₂CHOCH(OH)CH(OH)), 3.48-3.52 (m, 2H, (OH)CHCH(OH)CH(OH)), 3.76 (m, 1H, CH₂CH(OH)CH), 4.21 (d, 2H, OCH₂CH), 4.27 (m, 1H, CH₂CHOCH(OH)), 5.41 (d, 1H, OCH(OH)CH(OH)).

### EXAMPLE 39

20 g (0.078 mol) of 2-hexyl-3-hydroxy-decanoic β-lactone and 20.3 g (0.94 mol, 1.2 eq) of D-glucosamine hydrochloride were added to 200 ml of toluene. The solution was heated under reflux for 10-24 hours. The reaction solution was cooled to room temperature, 100 ml of water was added thereto, and the aqueous solution was neutralized with 1N NaOH. The neutral solution was extracted with methylene chloride (MC), the MC layer was dried with Na₂SO₄ and filtered, and the solvent was evaporated under reduced pressure. The residue was separated by column chromatography (MC:EtOH=20:1), and the solvent was evaporated under reduced pressure, yielding 14.3 g (42% yield) of N-(3′-D-glucosyl)-2-hexyl-3-hydroxy-decaneamid.

R_{f} (MC:EtOH=10:1): 0.38

¹H NMR (CDCl₃): δ 0.88 (t, 6H, CH₃), 1.12-1.91 (br, 22H, CH₂), 2.50 (m, 1H, CHCHCO), 3.40 (m, 1H, (OH)CHCH(OH)CHO CH₂), 3.43 (m, 1H, CH₂CH(OH)CH), 3.66 (d, 2H, CHCHOCH₂OH), 3.76 (m, 1H, CHCHOCH₂), 3.86 (m, 1H, (OH)CHCH(NH)CH(OH)), 4.03 (m, 1H, (OH)CHCH(OH)CH(NH)CH), 5.95 (m, 1H, CHCH(NH)CHO(OH)).

### COMPARATIVE EXAMPLE 11

10 g (39.7 mmol) of a C₈ alkyl ketene dimer was added to a solution of 3.18 g (79.4 mmol) of NaOH in 100 ml of 90% EtOH, and the mixture was allowed to react at 30-50° C. for 3 hours. Then, 3.26 g (89.3 mmol) of NaBH₄ was added thereto and the mixture was allowed to react at 30-40° C. for 10-24 hours. The reaction mixture was acidified with 1N hydrochloric acid and extracted with methylene chloride (MC). The MC layer was separated by column chromatography (MC:EtOH=45:1), and the solvent was evaporated under reduced pressure, yielding 6.8 g (63% yield) of 2-hexyl-3-hydroxy-decanoic acid as a light yellow syrup.

R_{f} (MC:EtOH=45:1): 0.48

¹H NMR (CDCl₃): δ 0.87 (t, 6H, CH₃), 1.12-1.91 (br, 22H, CH₂), 2.45 (m, 1H, CHCHCO), 3.76 (m, 1H, CH₂CH(OH)CH).

### COMPARATIVE EXAMPLE 12

10 g (18.8 mmol) of a C₁₆₋₁₈ alkyl ketene dimer was added to a solution of 1.50 g (37.6 mmol) of NaOH in 50 g of 90% ethanol, and the mixture was allowed to react 30-50° C. for 3 hours. Then, 1.00 g (26.3 mmol) of NaBH₄ was added thereto and the mixture was allowed to react at 30-40° C. for 10-24 hours. The reaction mixture was acidified by addition of 1N hydrochloric acid and extracted with methylene chloride (MC). The resulting white solid was recrystallized from EtOH, yielding 6.2 g (60% yield) of 2-hexadecyl/tetradecyl-3-hydroxy-eicosanoic/octadecanoic acid as a white solid.

Rf (MC:EtOH=45:1): 0.49

¹H NMR (CDCl₃): δ 0.86 (t, 6H, CH₃), 1.12-1.91 (br, 62H, CH₂), 2.46 (m, 1H, CHCHCO), 3.85 (m, 1H, CH₂CH(OH)CH).

The typical results are shown in Table 6 below.

TABLE 6

| | Starting | Reaction | H₂ | | |
|---|---|---|---|---|---|
| | Material | Solvent | Atmosphere | Catalyst | Yielding |
| Example 18 | C₈ alkyl ketene | EA:EtOH | 2 atm | 10% Pd/C | Step 1: 95% |
| | dimer | 3:1 | | | Step 2: 95% |
| | | | | | Total: 90.3% |
| Example 19 | C₈ alkyl ketene | EA:EtOH | 15 atm | 10% Pd/C | Step 1: 97% |
| | dimmer | 3:1 | | | Step 2: 95% |
| | | | | | Total: 92.2% |
| Example 20 | C₈ alkyl ketene | EtOH | 30 atm | 10% Pd/C | Step 1: 90% |
| | dimmer | | | | Step 2: 95% |
| | | | | | Total: 85.5% |
| Example 21 | C₈ alkyl ketene | EA:EtOH | 2 atm | 5% Pd/C | Step 1: 95% |
| | dimmer | 3:1 | | | Step 2: 95% |
| | | | | | Total: 90.3% |
| Example 22 | C₈ alkyl ketene | EA:EtOH | 15 atm | 5% Pd/C | Step 1: 95% |
| | dimmer | 2:1 | | | Step 2: 95% |
| | | | | | Total: 90.3% |
| Example 23 | C₈ alkyl ketene | EtOH | 40 atm | 5% Pd/C | Step 1: 89% |
| | dimmer | | | | Step 2: 95% |
| | | | | | Total: 84.6% |
| Example 24 | C₈ alkyl ketene | EA:EtOH | 2 atm | 0.5% Pd/Al₂O₃ | Step 1: 95% |
| | dimmer | 3:1 | | | Step 2: 95% |
| | | | | | Total: 90.3% |
| Example 25 | C₈ alkyl ketene | EA:EtOH | 15 atm | onetime | Step 1: 94% |
| | dimmer | 1:1 | | recycled | Step 2: 95% |
| | | | | 0.5% Pd/Al₂O₃ | Total: 89.3% |
| Example 26 | C₈ alkyl ketene | EtOH | 50 atm | twice recycled | Step 1: 88% |
| | dimmer | | | 0.5% Pd/Al₂O₃ | Step 2: 95% |
| | | | | | Total: 83.6% |
| Example 27 | C₁₂ alkyl ketene | EA:EtOH | 2 atm | 10% Pd/C | Step 1: 94% |
| | dimer | 2:1 | | | Step 2: 95% |
| | | | | | Total: 89.3% |
| Example 28 | C₁₂ alkyl ketene | EA:EtOH | 15 atm | 10% Pd/C | Step 1: 96% |
| | dimmer | 2:1 | | | Step 2: 95% |
| | | | | | Total: 91.2% |
| Example 29 | C₁₂ alkyl ketene | EA:EtOH | 15 atm | 5% Pd/C | Step 1: 93% |
| | dimmer | 1:1 | | | Step 2: 95% |
| | | | | | Total: 88.4% |
| Example 30 | C₁₂ alkyl ketene | EA:EtOH | 15 atm | five times | Step 1: 89% |
| | dimmer | 1:2 | | recycled | Step 2: 95% |
| | | | | 0.5% Pd/Al₂O₃ | Total: 84.6% |
| Example 31 | C₁₂ alkyl ketene | EtOH | 40 atm | 5% Pd/C | Step 1: 90% |
| | dimmer | | | | Step 2: 95% |
| | | | | | Total: 85.5% |
| Example 32 | C_{16–18} alkyl | EA:EtOH | 2 atm | 10% Pd/C | Step 1: 92% |
| | ketene dimer | 1:1 | | | Step 2: 95% |
| | | | | | Total: 87.4% |
| Example 33 | C_{16–18} alkyl | EtOH | 2 atm | 10% Pd/C | Step 1: 94% |
| | ketene dimmer | | | | Step 2: 95% |
| | | | | | Total: 89.3% |
| Example 34 | C_{16–18} alkyl | EtOH | 30 atm | 5% Pd/C | Step 1: 94% |
| | ketene dimmer | | | | Step 2: 95% |
| | | | | | Total: 89.3% |
| Example 35 | C_{16–18} alkyl | EtOH | 50 atm | ten times | Step 1: 91% |
| | ketene dimmer | | | recycled | Step 2: 95% |
| | | | | 0.5% Pd/Al₂O₃ | Total: 86.5% |
| Example 36 | C_{16–18} alkyl | EtOH | 50 atm | 0.5% Pd/Al₂O₃ | Step 1: 95% |
| | ketene dimmer | | | | Step 2: 95% |
| | | | | | Total: 90.3% |
| Comp. | C₈ alkyl ketene | EtOH | | NaBH₄ | |
| Example 11 | dimer | | | | |
| Comp. | C_{16–18} alkyl | EtOH | | NaBH₄ | |
| Example 12 | ketene dimer | | | | |

### EXAMPLE 40

### Evaluation of Emulsification Activity of 2-alkyl-3-hydroxylic Acid for Hydrocarbon

In this Example, 2-hexyl-3-hydroxy-decanoic acid was selected from among 2-alkyl-hydroxylic acids, biosurfactants which can be effectively used in the inventive bioremediation method. The selected compound was evaluated with respect to emulsification activity (E₂₄ %) for n-tetradecane and cyclohexane, in comparison with synthetic nonionic surfactant Tween 80 and another biosurfactant rhamnolipid secreted by microorganisms.

In this experiment, 5 ml of n-tetradecane or cyclohexane was added to 5 ml of alkaline distilled water (pH 9.5) containing each of 10 ppm, 100 ppm and 1000 ppm of 2-hyxyl-3-hydroxy-decanoic acid in test tubes, and the mixture was strongly vortexed for 2 minutes, left to stand at 30° C. for 24 hours and then measured for emulsion stability. Tween 80 and rhamnolipid were also treated in the same manner as described above and were measured for emulsification activity, and the measured emulsification activities were compared with that of 2-hexyl-3-hydroxy-decanoic acid.

The emulsion stability value (E₂₄ %) was evaluated in the same manner as the emulsification activity value and calculated by dividing the height of an emulsion layer in the test tube by the total weight of the test tube and then multiplying the divided value by 100%.

FIG. 12 shows the results of evaluation for the emulsification activities of biosurfactant 2-hexyl-3-hydroxy-decanoic acid, Tween 80 and rhamnolipid for n-tetradecane and cyclohexane as a function of the concentration of each of the surfactants.

In FIG. 12, the concentrations of the surfactant are 10 ppm, 100 ppm and 1,000 ppm, the bar “□” indicates emulsification activity for n-tetradecane, and the bar “▪” indicates emulsification activity for cyclohexane.

As shown in FIG. 12, the emulsification activity of synthetic biosynthetic 2-hexyl-3-hydroxy-decanoic acid for n-tetradecane and cyclohexane was similar to those of nonionic surfactant Tween 80 and another biosurfactant rhamnolipid at surfactant concentrations of 100 ppm and 1,000 ppm. This suggests that synthetic biosurfactant 2-hexyl-3-hydroxy-decanoic acid can effectively reduce interfacial tension for a wide spectrum of oils, as Tween 80 or rhamnolipid does.

As described above, the novel microorganisms according to the present invention has excellent biodegradability for a wide spectrum of oils. Also, according to the inventive method for the bioremediation of oil-contaminated soils, the contaminated soils can be purified in an effective, economical and eco-friendly manner compared to the prior bioremediation methods, through the use of at least one selected from among various microbial strains having oil degradability isolated from oil-contaminated soils, including the novel microorganisms, in combination with biosurfactant 2-alkyl-3-hydroxylic acid or its derivative, which serves to increase these microbial strains' biodegradability and can be prepared with high yield in an effective and easy manner.

Although the preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. Rhodococcus baikoneurensis EN3 KCTC19082 having oil biodegradability.

2. Acinetobacter johnsonii EN67 KCTC12360 having oil biodegradability.

3. Acinetobacter haemolyticus EN96 KCTC12361 having oil biodegradability.

4. A method for the bioremediation of oil-contaminated soil, which comprises: inoculating the oil-contaminated soil with at least one microbial strain selected from the group consisting of the following microbial strains; and proliferating the inoculated microbial strain to biodegrade and remove the oil: Rhodococcus baikoneurensis EN3 KCTC19082, Acinetobacter johnsonii EN67 KCTC12360, Acinetobacter haemolyticus EN96 KCTC12361, Nocardia transvalensis DSM43405^{T}, Nocardia asteroides ATCC19247^{T}, Gordonia sputi DSM43896^{T}, Gordonia rhizosphera IFO16068^{T}, Gordonia nitida LE31^{T}, Gordonia hirsuta DSM44140^{T}, Gordonia bronchialis CIP1780.88^{T}, Gordonia amarae DSM43392^{T}, Gordonia desulfuricans NCIMB40816^{T}, Rhodococcus zopfii ATCC51349^{T}, Rhodococcus wratislaviensis NCIMB13082^{T}, Rhodococcus tukisamuensis Mb8^{T}, Rhodococcus ruber DSM43338^{T}, Rhodococcus rhodochrous CIP1759.88^{T}, Rhodococcus rhodnii DSM43336^{T}, Rhodococcus pyridinovorans KCTC0647BP^{T}, Rhodococcus percolatus MBS1^{T}, Rhodococcus opacus DSM43205^{T}, Rhodococcus marinonascens DSM43752^{T}, Rhodococcus koreensis DNP505^{T} type2, Rhodococcus jostii IFO16295^{T}, Rhodococcus globerulus DSM43954^{T}, Rhodococcus fascians DSM20669^{T}, Rhodococcus erythropolis ATCC4277^{T}, Rhodococcus erythreus DSM43066^{T}, Rhodococcus equi DSM20307^{T}, Rhodococcus coprophilus ATCC29080^{T}, Rhodococcus baikonurensis GTC 1041^{T}, Acinetobacter towneri AB1110^{T}, Acinetobacter baylyi B2^{T}, Acinetobacter calcoaceticus DSM30006^{T}, Acinetobacter grimontii 17A04^{T}, Acinetobacter lwoffii DSM2403^{T}, Acinetobacter radioresistens ATCC17909^{T}, Acinetobacter tandoii 4N13^{T}, Acinetobacter towneri AB1110^{T}, Acinetobacter baumannii ATCC19606^{T}, Acinetobacter bouvetii 4B02^{T}, Acinetobacter gerneri 9A01^{T}, Acinetobacter junii ATCC17908^{T}, Acinetobacter parvus LUH4616^{T}, Acinetobacter schindleri NIPH1034^{T}, Acinetobacter tjernbergiae 7N16^{T} and Acinetobacter ursingii NIPH137^{T}.

5. The method of claim 4, wherein biosurfactant 2-alkyl-3-hydroxylic acid represented by Formula 1, or its derivative, is added as an oil biodegradation activator. 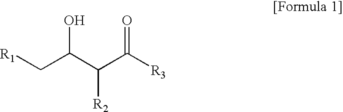
wherein R₁ and R₂ each independently represents a C4-C50 straight or branched-chain alkyl group including hydroxy, methoxy, keto, carbonyl, carboxy, epoxy, ester or a cyclopropane ring, and R₃ represents —OR₄, monoethanolamine, diethanolamine, D-glucosamine, glucamine, N-methylglucamine, glucose, ramnose, mannose, galactose, lactose, sucrose, maltose, arabinose, cellobiose, or polysaccharide including said monosaccharide or disaccharide, wherein R₄ represents hydrogen, sodium, potassium, magnesium, calcium, ammonium or triethanolamine.

6. The method of claim 4, wherein the microbial strain is a strain isolated and identified by: a step of isolating microbial strains from oil-contaminated soils; a step of culturing the isolated strains; a first screening step of screening strains having excellent oil biodegradability from the cultured strains; and a second screening step of screening microbial strains, the ability of which to degrade a high concentration of oil contaminants is increased through a biosurfactant, from the microbial strains screened in the first screening step.

7. The method of claim 6, wherein the biosurfactant is 2-alkyl-3-hydroxylic acid according to claim 5, or its derivative.

8. The method of claim 5, wherein the inoculation level (including medium weight) of the microbial strain is in the range of 0.001-8% (v/v or v/w), and the amount of addition of the biosurfactant is in the range of 0.0001-10 wt % based on the inoculation level (including medium weight) of the microbial strain.

9. The method of claim 5, wherein the biosurfactant 2-alkyl-3-hydroxylic acid represented by Formula 1, or its derivative, is prepared through a first step reaction of hydrogenating an alkyl ketene dimer in a hydrogen atmosphere to form β-lactone, and a second step reaction of either subjecting the β-lactone to ring-opening reaction to prepare 2-alkyl-3-hydroxylic acid or allowing the β-lactone to react with sugar and a nucleophile to form a derivative of 2-alkyl-3-hydroxylic acid.

10. The method of claim 9, wherein the hydrogenation in the first step reaction is carried out using Pd/C or Pd/Al₂O₃ as a hydrogenation catalyst at a hydrogen pressure of 1-50 atm.

11. The method of claim 9, wherein a solvent in the first step reaction is a mixture of ethyl acetate and ethyl alcohol (5%:95%-95%:5% v/v).

12. The method of claim 5, wherein R₁ and R₂ in Formula 1 are each independently a C4-50 straight or branched-chain alkyl group including hydroxyl, methoxy, keto, carbonyl, carboxy, epoxy ester or a cyclopropane ring.

13. The method of claim 9, wherein the sugar used in the reaction with the nucleophile is at least one selected from the group consisting of glucose, ramnose, mannose, galactose, lactose, sucrose, maltose, arabinose and cellobiose.


SEQUENCE LISTING (3 sequences)

SEQ ID NO: 1 - DNA, 1450 bp, Rhodococcus sp. EN3
tggctcaggacgaacgctggcggcgtgcttaacacatgcaagtcgagcggtaaggcctttcggggtacacgagcggcgaacgggtgagtaacacgtgggtgatctgccctgcacttcgggataagcctgggaaactgggtctaataccggatatgacctcctatcgcatggtgggtggtggaaagatttatcggtgcaggatgggcccgcggcctatcagcttgttggtggggtaatggcctaccaaggcgacgacgggtagccgacctgagagggtgaccggccacactgggactgagacacggcccagactcctacgggaggcagcagtggggaatattgcacaatgggcgaaagcctgatgcagcgacgccgcgtgagggatgacggccttcgggttgtaaacctctttcagcagggacgaagcgcaagtgacggtacctgcagaagaagcaccggctaactacgtgccagcagccgcggtaatacgtagggtgcaagcgttgtccggaattactgggcgtaaagagttcgtaggcggtttgtcgcgtcgtttgtgaaaaccagcagctcaactgctggcttgcaggcgatacgggcagacttgagtactgcaggggagactggaattcctggtgtagcggtgaaatgcgcagatatcaggaggaacaccggtggcgaaggcgggtctctgggcagtaactgacgctgaggaacgaaagcgtgggtagcgaacaggattagataccctggtagtccacgccgtaaacggtgggcgctaggtgtgggttccttccacggaatccgtgccgtagctaacgcattaagcgccccgcctggggagtacggccgcaaggctaaaactcaaaggaattgacgggggcccgcacaagcggcggagcatgtggattaattcgatgcaacgcgaagaaccttacctgggtttgacatataccggaaagctgcagagatgtggccccccttgtggtcggtatacaggtggtgcatggctgtcgtcagctcgtgtcgtgagatgttgggttaagtcccgcaacgagcgcaacccctatcttatgttgccagcacgttatggtggggactcgtaagagactgccggggtcaactcggaggaaggtggggacgacgtcaagtcatcatgccccttatgtccagggcttcacacatgctacaatggccagtacagagggctgcgagaccgtgaggtggagcgaatcccttaaagctggtctcagttcggatcggggtctgcaactcgaccccgtgaagtcggagtcgctagtaatcgcagatcagcaacgctgcggtgaatacgttcccgggccttgtacacaccgcccgtcacgtcatgaaagtcggtaaccacccgaagccggtggcttaaccccttgtgggagggagccgtcgaaggtgggatcggcgattgggacga

SEQ ID NO: 2 - DNA, 1389 bp, Acinetobacter sp. EN67
gctcagattgaacgctggcggcaggcttaacacatgcaagtcgagcggggagatgtagcttgctacatttcctagcggcggacgggtgagtaatgcttaggaatctgcctattagtgggggacaacattccgaaaggaatgctaataccgcatacgccctacgggggaaagcaggggatcttcggaccttgcgctaatagatgagcctaagtcagattagctagttggtggggtaaaggcctaccaaggcgacgatctgtagcgggtctgagaggatgatccgccacactgggactgagacacggcccagactcctacgggaggcagcagtggggaatattggacaatgggcgaaagcctgatccagccatgccgcgtgtgtgaagaaggccttttggttgtaaagcactttaagcgaggaggaggctacttagattaatactctaggatagtggacgttactcgcagaataagcaccggctaactctgtgccagcagccgcggtaatacagagggtgcgagcgttaatcggatttactgggcgtaaagcgtgcgtaggcggcttcttaagtcggatgtgaaatccctgagcttaacttaggaattgcattcgatactgggaagctagagtatgggagaggatggtagaattccaggtgtagcggtgaaatgcgtagagatctggaggaataccgatggcgaaggcagccatctggcctaatactgacgctgaggtacgaaagcatggggagcaaacaggattagataccctggtagtccatgccgtaaacgatgtctactagccgttggggcctttgaggctttagtggcgcagctaacgcgataagtagaccgcctggggagtacggtcgcaagactaaaactcaaatgaattgacgggggcccgcacaagcggtggagcatgtggtttaattcgatgcaacgcgaagaaccttacctggtcttgacatagtaagaactttccagagatggattggtgccttcgggaacttacatacaggtgctgcatggctgtcgtcagctcgtgtcgtgagatgttgggttaagtcccgcaacgagcgcaacccttttccttatttgccagcgggttaagccgggaactttaaggatactgccagtgacaaactggaggaaggcggggacgacgtcaagtcatcatggcccttacgaccagggctacacacgtgctacaatggtcggtacaaagggttgctacctagcgataggatgctaaactcaaaaagccgatcgtagtccggattggagtctgcaactcgactccatgaagtcggaatcgctagtaatcgcggaacagaatgccgcggtgaatacgttcccgggcctgtaacaccgcccgtgcaccatggg

SEQ ID NO: 3 - DNA, 1450 bp, Acinetobacter sp. EN96
ctggcggcaggcttaacacatgcaagtcgagcggggaagtgtagcttgctacattacctagcggcggacgggtgagtaatgcttaggaatctgcctattagtgggggacaacattccgaaaggaatgctaataccgcatacgtcctacgggagaaagcaggggatcttcggaccttgcgctaatagatgagcctaagtcggattagctagttggtggggtaaaggcctaccaaggcgacgatctgtagcgggtctgagaggatgatccgccacactgggactgagacacggcccagactcctacgggaggcagcagtggggaatattggacaatggggggaaccctgatccagccatgccgcgtgtgtgaagaaggccttatggttgtaaagcactttaagcgaggaggaggctactctagataatacctagagatagtggacgttactcgcagaataagcaccggctaactctgtgccagcagccgcggtaatacagagggtgcgagcgttaatcggatttactgggcgtaaagcgtgcgtaggcggctgattaagtcggatgtgaaatccctgagcttaacttaggaattgcattcgatactggtcagctagagtatgggagaggatggtagaattccaggtgtagcggtgaaatgcgtagagatctggaggaataccgatggcgaaggcagccatctggcctaatactgacgctgaggtacgaaagcatggggagcaaacaggattagataccctggtagtccatgccgtaaacgatgtctactagccgttggggcctttgaggctttagtggcgcagctaacgcgataagtagaccgcctggggagtacggtcgcaagactaaaactcaaatgaattgacgggggcccgcacaagcggtggagcatgtggtttaattcgatgcaacgcgaagaaccttacctggtcttgacatagtaagaactttccagagatggattggtgccttcgggaacttacatacaggtgctgcatggctgtcgtcagctcgtgtcgtgagatgttgggttaagtcccgcaacgagcgcaacccttttccttacttgccagcatttcggatgggaactttaaggatactgccagtgacaaactggaggaaggcggggacgacgtcaagtcatcatggcccttacgaccagggctacacacgtgctacaatggtcggtacaaagggttgctacctagcgataggatgctaatctcaaaaagccgatcgtagtccggattggagtctgcaactcgactccatgaagtcggaatcgctagtaatcgcggatcagaatgccgcggtgaatacgttcccgggccttgtacacaccgcccgtcacaccatgggagtttgttgcaccagaagtaggtagtctaaccgcaaggaggacgcttaccacggtgtggccgatgactggggt